(19) United States
(12) Patent Application Publication
(10) Pub. No.: US 2010/0141991 A1
(43) Pub. Date: Jun. 10, 2010

(54) IMAGE PROCESSING APPARATUS, IMAGE FORMING APPARATUS, AND IMAGE PROCESSING METHOD

(76) Inventors: Akihito YOSHIDA, Osaka (JP); Hitoshi Hirohata, Osaka (JP)

Correspondence Address: BIRCH STEWART KOLASCH & BIRCH, PO BOX 747, FALLS CHURCH, VA, 22040-0747, US

(21) Appl. No.: 12/634,207

(22) Filed: Dec. 9, 2009

(30) Foreign Application Priority Data
Dec. 10, 2008 (JP) 2008-314684
Oct. 30, 2009 (JP) 2009-251213

(51) Int. Cl. G06F 3/12; H04N 1/047

(52) U.S. Cl. 358/1.15; 358/488; 358/1.18

(57) ABSTRACT

An image processing apparatus includes: a document detection section for detecting, according to image data of a document image, an image processing condition to be applied at a time when the document image is displayed or printed; a draw command generation section for generating a draw command for controlling a computer so as to cause the computer to perform display or printing after image processing in accordance with the image processing condition, at the time when the document image is displayed or printed; a formatting process section for generating an image file in which the draw command is added to the image data that has not been subjected to the image processing. This makes it possible to rapidly generate an image file of image data obtained by reading a document and also makes it possible to cause a device that displays or prints the image data to perform appropriate image processing.

This Nonprovisional application claims priority under 35 U.S.C. §119(a) on Patent Applications No. 2008-314684 filed in Japan on Dec. 10, 2008 and No. 2009-251213 filed in Japan on Oct. 30, 2009, the entire contents of which are hereby incorporated by reference.

### TECHNICAL FIELD

The present invention relates to an image processing apparatus, an image reading apparatus, an image transmitting device, an image forming apparatus, an image processing method, and a program and a storage medium thereof, each of which is for transmitting image data that has been read from a document and that has been subjected to a predetermined process.

### BACKGROUND ART

Conventionally, information described on a recording material is transcribed into an electronic document by a following procedure. First, information described on a recording material such as paper is read so that image data is generated. The image data is converted into, for example, a TIFF, GIF, PDF, or bitmap-format image file and transmitted, as an attachment to a mail or the like, to a server or a computer connected via a network. (See Patent Literature 1, for example.)

In a case where the document is read by a scanner, the document may be read while the document is skewed or a top of the document is placed at a bottom (the document is placed upside down, a top-to-bottom direction of the document is reversed). In order to solve this problem, in a conventional technique, an image file is transmitted after the image data read from the document has been subjected to processes such as skew correction and top-to-bottom direction correction.

However, a rotation process of the image data is a heavy load and takes a long time. Accordingly, the rotation process increases a time for processes from reading of the document to transmission of the image data, which is a problem.

In order to solve this problem, a possible procedure may be as follows. First, information necessary for image processing is extracted from the image data read from the document, and an image file is generated so that the image file includes the image data that has not been subjected to the image processing yet and the information necessary for the image processing. Then, the image file is transmitted, and a device having received this image file subjects the image data to image processing.
Note that Patent Literature 2 discloses a technique for generating an image file including image data and information regarding image processing to be applied to this image data. The technique disclosed in Patent Literature 2 is intended to solve a problem such that the document cannot be correctly converted to an electronic data due to (i) omission of a part of the document in reading as a result of reading in a state where the document is fed too far or fed insufficiently by an ADF or (ii) reading based on an automatic determination which wrongly determines a document size. According to Patent Literature 2, the image file is generated so that in the image file, the image data read from the document is associated with a crop box (information of a display area) in accordance with a sheet size inputted by a user regarding the document. Then, when a document image is displayed according to this image file, only an image section of the crop box is clipped (cropped) from the image data and displayed.
Patent Literature 3 discloses the following technique. First, a document format is produced so as to include page image information of a document, thumbnail image information that is obtained by reducing the page image information, and draw command information for rotating the page image information based on a set value inputted from a user. Then, when the thumbnail image is displayed, the thumbnail image is rotated according to the draw command information included in the document format. As a result, the thumbnail image information is displayed in a direction that is the same as a direction in which the page image information is displayed.

### Patent Literature 1

Japanese Patent Application Publication, Tokukai, No. 2002-215549 A (Publication Date: Aug. 2, 2002)

### Patent Literature 2

Japanese Patent Application Publication, Tokukai, No. 2007-174479 A (Publication Date: Jul. 5, 2007)

### Patent Literature 3

Japanese Patent Application Publication, Tokukai, No. 2008-125026 A (Publication Date: May 29, 2008)

### Patent Literature 4

Japanese Patent Application Publication, Tokukaihei, No. 7-192086 A (Publication Date: Jul. 28, 1995)

### Patent Literature 5

Japanese Patent Application Publication, Tokukaihei, No. 6-189083 A (Publication Date: Jul. 8, 1994)

### SUMMARY OF INVENTION

### Technical Problem

However, according to techniques of Patent Literatures 2 and 3, regardless of a process mode, a processing condition, or the like which is to be applied to image data, an image file to which information of a crop box or information of a rotation process are added is produced. Accordingly, in a case where a process for extracting a display area from the image data or a rotation process is unnecessary, an unnecessary process is performed. This may make it impossible to sufficiently reduce a process time from reading of a document to transmission of the image file. Further, according to techniques of Patent Literatures 2 and 3, depending on a crop box or a content of draw command information, a load on a display device for performing display according to the information becomes heavy. This results in a long time taken before the display or a flicker in the display.

The present invention is attained in view of the problems above. An object of the present invention is to make it possible to rapidly generate an image file in a predetermined format based on image data obtained by reading a document and also to appropriately draw an image in accordance with the image data.

### Solution to Problem

In order to solve the problems mentioned above, the image processing apparatus of the present invention includes: a formatting process section for generating an image file obtained by formatting, into data of a predetermined format, image data of a document image obtained by reading a document; a condition detection section for detecting, in accordance with the image data, an image processing condition to be applied at a time when the document image is drawn; a draw command generation section for generating a draw command for controlling a computer so as to cause the computer to draw the document image in a state in which image processing in accordance with the image processing condition has been performed, at the time when the document image is drawn; an image processing section for subjecting the image data to the image processing in accordance with the image processing condition detected by the condition detection section; and a control section for controlling an operation of each of the formatting process section, the condition detection section, the draw command generation section, and the image processing section, so that: in a case where the image processing condition detected by the condition detection section satisfies a predetermined requirement, the control section causes the formatting process section to perform a process of a simple mode; and in a case the image processing condition detected by the condition detection section does not satisfy the predetermined requirement, the control section causes the formatting process section to perform a process of a regular mode, in the regular mode, the formatting process section generating an image file obtained by formatting the image data on which the image processing section has performed the image processing, in the simple mode, the formatting processing section generating an image file obtained by adding the draw command generated by the draw command generation section to the image data that has not been subjected to the image processing.

According to the configuration, in a case where the condition detected satisfies the predetermined requirement, an image file is generated according to the image data that is for the document image and that has not been subjected to the image processing. This makes it possible to rapidly perform a process such as transmission or filing of the image file. Further, when the document image is drawn (e.g., when the document image is displayed on a display or the document image is printed on a recording material), it is possible to control a computer so that the computer draws the document image in the state in which the image processing in accordance with the image processing condition has been performed.

Further, in a case where the condition detected does not satisfy the predetermined requirement, the control section causes the image processing section to perform, on the image data, image processing in accordance with the condition detected by the condition detection section and also causes the formatting process section to generate the image file in accordance with the image data having been subjected to the image processing. Accordingly, for example, if the requirement is set in accordance with a relation between the condition detected by the condition detection section and a load or a processing speed of the image processing apparatus, it becomes possible to appropriately switch whether or not to perform image processing in consideration of the load, the processing speed, or the like of the image processing apparatus at the time when an image file generated previously in the regular mode or the simple mode is subjected to drawing. In the present invention, the term “draw” is used to describe display or print.

### ADVANTAGEOUS EFFECTS OF INVENTION

As described above, the image processing apparatus of the present invention includes: a formatting process section for generating an image file obtained by formatting, into data of a predetermined format, image data of a document image obtained by reading a document; a condition detection section for detecting, in accordance with the image data, an image processing condition to be applied at a time when the document image is drawn; a draw command generation section for generating a draw command for controlling a computer so as to cause the computer to draw the document image in a state in which image processing in accordance with the image processing condition has been performed, at the time when the document image is drawn; an image processing section for subjecting the image data to the image processing in accordance with the image processing condition detected by the condition detection section; and a control section for controlling an operation of each of the formatting process section, the condition detection section, the draw command generation section, and the image processing section, so that: in a case where the image processing condition detected by the condition detection section satisfies a predetermined requirement, the control section causes the formatting process section to perform a process of a simple mode; and in a case the image processing condition detected by the condition detection section does not satisfy the predetermined requirement, the control section causes the formatting process section to perform a process of a regular mode, in the regular mode, the formatting process section generating an image file obtained by formatting the image data on which the image processing section has performed the image processing, in the simple mode, the formatting processing section generating an image file obtained by adding the draw command generated by the draw command generation section to the image data that has not been subjected to the image processing.

An image processing method of the present invention in an image processing apparatus generating an image file obtained by formatting, into data of a predetermined format, image data of a document image obtained by reading a document, the image processing method includes the steps of: detecting, by a condition detection section provided in the image processing apparatus, an image processing condition to be applied at a time when the document image is drawn, in accordance with the image data; and determining, by a control section provided in the image processing apparatus, whether or not the image processing condition detected in the step of detecting the image processing condition satisfies a predetermined requirement, in a case where the image processing condition detected in the step of detecting the image processing condition is determined to satisfy the predetermined requirement, the control section (i) causing the draw command generation section provided in the image processing apparatus to generate a draw command for controlling a computer so as to cause the computer to draw the document image in a state in which image processing in accordance with the image processing condition has been performed, at the time when the document image is drawn, and (ii) causing an image file generation section provided in the image processing apparatus to generate an image file in which the draw command is added to the image data that has not been subjected to the image processing, in a case where the image processing condition detected in the step of detecting the image processing condition is not determined to satisfy the predetermined requirement, the control section (i) causing the image processing section provided in the image processing apparatus to subject the image data to the image processing in accordance with the image processing condition detected in the step of detecting the image processing condition, and (ii) causing the image file generation section to generate an image file obtained by formatting the image data that has been subjected to the image processing.

Therefore, in a case where the condition detected satisfies the predetermined requirement, a process such as transmission or filing of the image file can be rapidly performed. Further, when the document image is drawn, it is possible to control a computer so that the computer draws the document image in the state in which the image processing in accordance with the image processing condition has been performed Meanwhile, in a case where the condition detected does not satisfy the predetermined requirement, the image file obtained by formatting the image data having been subjected to the image processing can be generated. Accordingly, it becomes possible to appropriately switch whether or not to perform image processing in consideration of a load, a processing speed, or the like of the image processing apparatus at the time when an image file generated previously in the regular mode or the simple mode is subjected to drawing.

### BRIEF DESCRIPTION OF DRAWINGS

FIG. 1 is a flow chart illustrating a process flow in an image processing apparatus according to one embodiment of the present invention.

FIG. 2 is a block diagram schematically illustrating a configuration of an image processing apparatus (image reading apparatus, image forming apparatus) according to one embodiment of the present invention and a data flow in an image forming mode.

FIG. 3 is a block diagram illustrating a data flow in a regular transmission mode in the image processing apparatus shown in FIG. 2.

FIG. 4 is a block diagram illustrating a data flow in a simple transmission mode in the image processing apparatus shown in FIG. 2.

FIG. 5 is a cross sectional view illustrating an example of a configuration of an image input apparatus provided in the image processing apparatus shown in FIG. 2.

FIG. 6 is a block diagram schematically illustrating a configuration of a document detection section provided in the image processing apparatus shown in FIG. 2.

FIG. 7 is an explanatory diagram illustrating one example of a relation between a reading area and a document position at the time of reading in the image input apparatus shown in FIG. 5.

FIG. 8 is an explanatory diagram illustrating a relation between a top-to-bottom direction of image data and a top-to-bottom direction of a document image in the image processing apparatus shown in FIG. 2.

FIG. 9 is an explanatory diagram illustrating a determination method of an image region in the image processing apparatus shown in FIG. 2.

FIG. 10 is a graph illustrating one example of a gamma curve employed in a halftone correction process in the image processing apparatus shown in FIG. 2.

FIG. 11 is an explanatory diagram illustrating a configuration of an image file transmitted in a simple transmission mode in the image processing apparatus shown in FIG. 2.

FIG. 12(a) is a view illustrating one example of description contents for a document catalog description section of the image file shown in FIG. 11.

FIG. 12(b) is a view illustrating one example of description contents for a page description section of the image file shown in FIG. 11.

FIG. 12(c) is a view illustrating one example of description contents for an image data description section of the image file shown in FIG. 11.

FIG. 13(a) is a diagram illustrating one example of image data read by the image input apparatus shown in FIG. 2.

FIG. 13(b) is an explanatory diagram illustrating an image obtained by displaying the image data shown in FIG. 13(a) in accordance with description in an image drawing description section shown in FIG. 14.

FIG. 14 is an explanatory view illustrating one example of description contents for an image drawing description section in an image file that is to be transmitted in a simple transmission mode, in the image processing apparatus shown in FIG. 2.

FIG. 15(a) is a diagram illustrating one example of image data read by the image input apparatus shown in FIG. 2.

FIG. 15(b) is an explanatory diagram illustrating an image obtained by displaying the image data shown in FIG. 13(a) in accordance with description in an image drawing description section shown in FIG. 16.

FIG. 16 is an explanatory view illustrating one example of description contents for an image drawing description section in an image file that is to be transmitted in a simple transmission mode, in the image processing apparatus shown in FIG. 2.

FIG. 17(a) is a diagram illustrating one example of image data read by the image input apparatus shown in FIG. 2.

FIG. 17(b) is an explanatory diagram illustrating an image obtained by displaying the image data shown in FIG. 17(a) in accordance with description in an image drawing description section shown in FIG. 18.

FIG. 18 is an explanatory view illustrating one example of description contents for an image drawing description section in an image file that is to be transmitted in a simple transmission mode, in the image processing apparatus shown in FIG. 2.

FIG. 19(a) is a diagram illustrating one example of image data read by the image input apparatus shown in FIG. 2.

FIG. 19(b) is an explanatory diagram illustrating an image obtained by displaying the image data shown in FIG. 19(a) in accordance with description in an image drawing description section shown in FIG. 20.

FIG. 20 is an explanatory view illustrating one example of description contents for in an image drawing description section in an image file that is to be transmitted in a simple transmission mode, in the image processing apparatus shown in FIG. 2.

FIG. 21 is a block diagram illustrating a modified example of the image processing apparatus shown in FIG. 2.

FIG. 22 is a block diagram illustrating a modified example of the image processing apparatus shown in FIG. 2.

FIG. 23 is a block diagram illustrating a modified example of the image processing apparatus shown in FIG. 2.

FIG. 24 is an explanatory diagram illustrating a relation between (i) a document placement orientation and (ii) scanning resolutions in a main scanning direction and in a sub-scanning direction.

FIG. 25 is a flow chart illustrating a modified example of processes in an image processing apparatus according to one embodiment of the present invention.

FIG. 26 is a flow chart illustrating a modified example of processes in an image processing apparatus according to one embodiment of the present invention.

FIG. 27 is a flow chart illustrating a modified example of processes in an image processing apparatus according to one embodiment of the present invention.

FIG. 28 is a flow chart illustrating a modified example of processes in an image processing apparatus according to one embodiment of the present invention.

### REFERENCE SIGNS LIST

1 Digital Color Multifunction Printer (Image Processing Apparatus, Image Forming Apparatus, Image Reading Apparatus)
2 Image Input Apparatus
3, 3b Image Processing Apparatus
4 Image Output Apparatus
5 Communication Device
6 Operation Panel
14 Document Detection Section (Condition Detection Section)
15 Document Correction Section
21 Segmentation Process Section
22 Transmission Data Generation Section
23 Storage Section
24 Control Section
31 Signal Conversion Section
32 Binarization Process Section
33 Resolution Conversion Section
34 Document Skew Detection Section
35 Document Top-to-Bottom Determination Section
36 Image Region Determination Section
41 Information Extraction Section
42 Character Recognition Section
43 Draw Command Generation Section
44 Formatting Process Section
100 Image Reading Apparatus (Image Processing Apparatus, Image Reading Apparatus)

### DESCRIPTION OF EMBODIMENTS

One embodiment of the present invention is described below. Note that the present embodiment explains mainly one example of a case where the present invention is applied to a digital color multifunction printer.

Whole Configuration of Digital Color Multifunction Printer

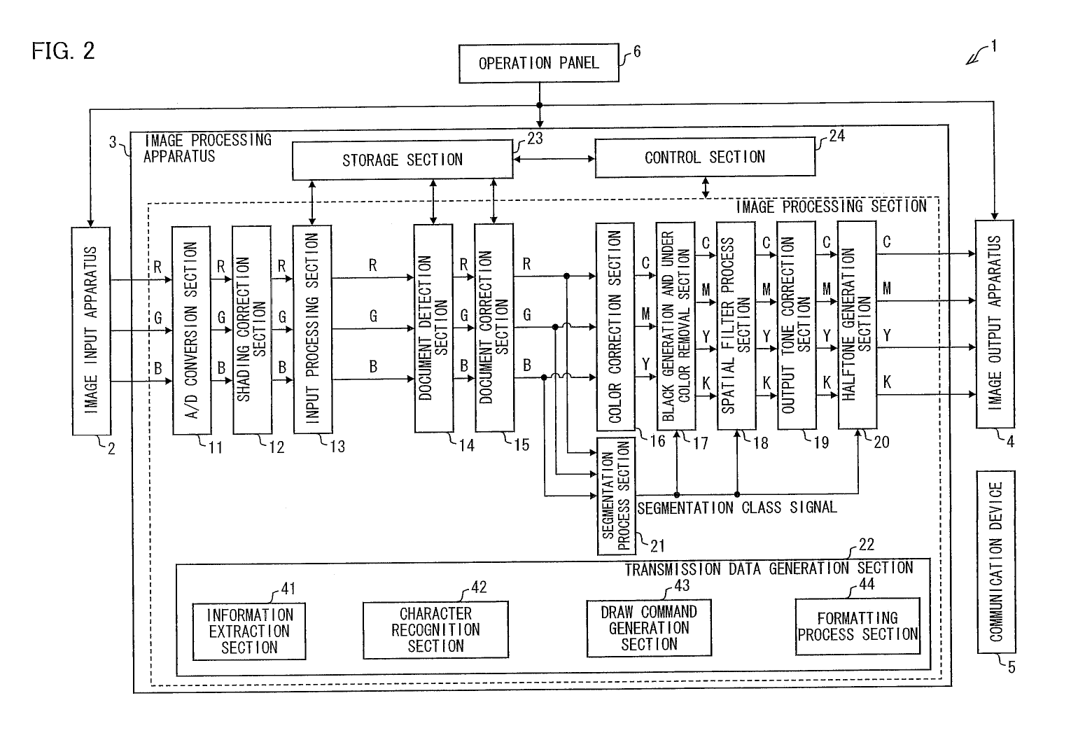

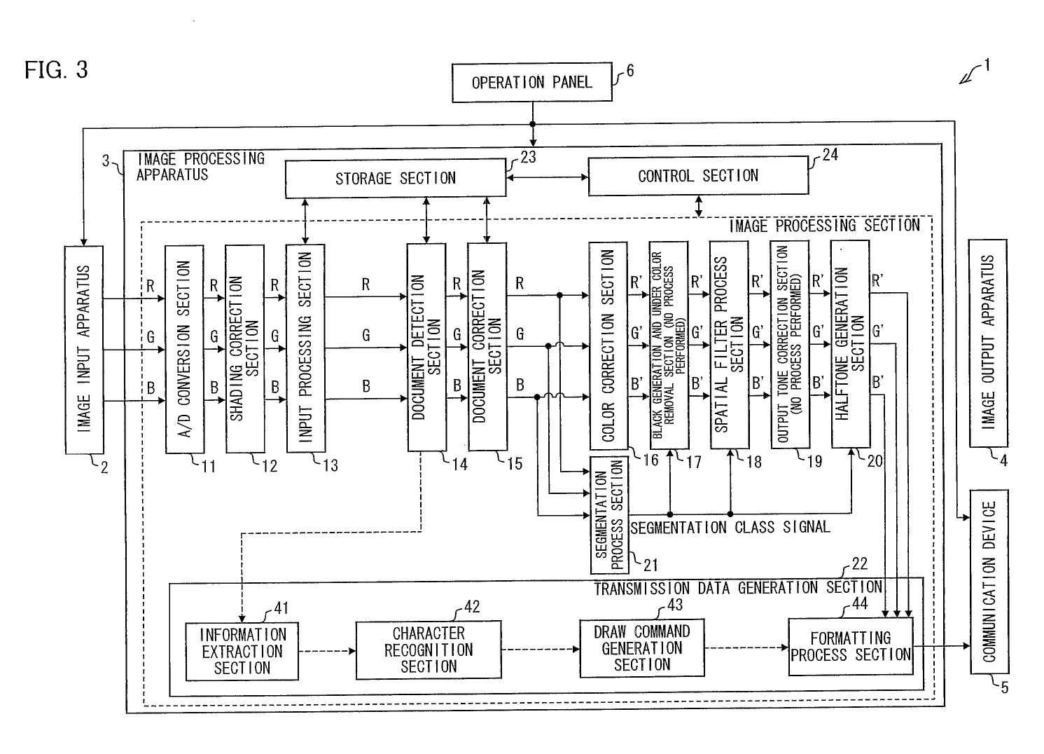

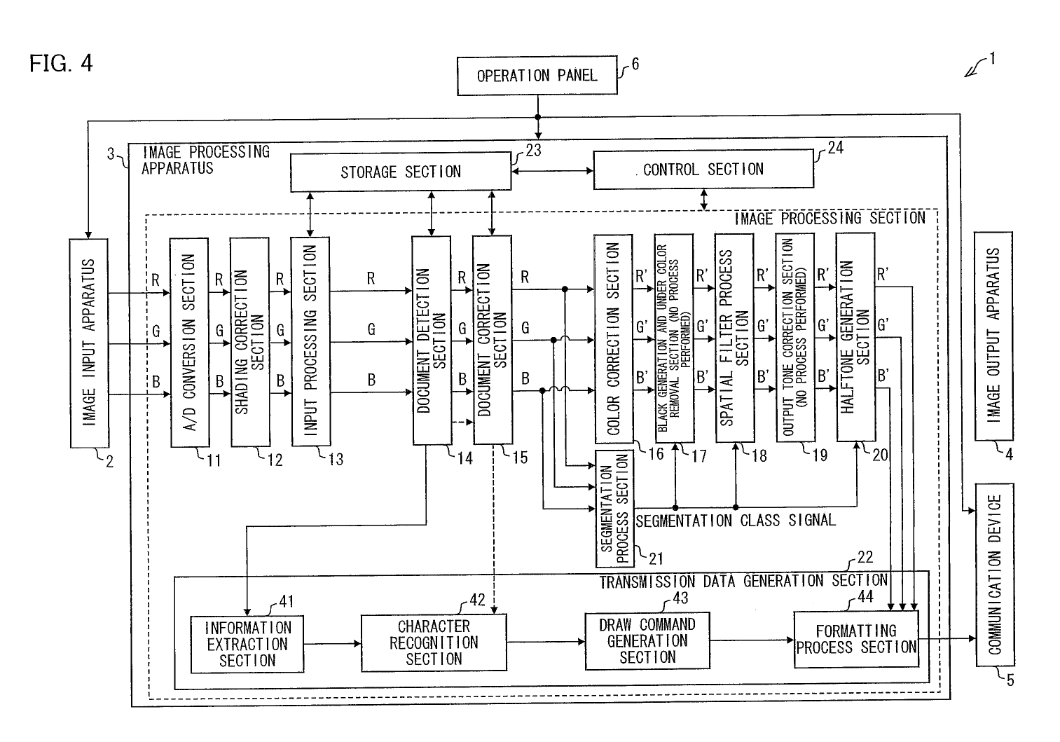

FIGS. 2 to 4 are block diagrams schematically illustrating a configuration of a digital color multifunction printer 1 of the present embodiment. Note that the digital color multifunction printer 1 has (1) an image forming mode in which an image corresponding to image data read by an image input apparatus 2 is formed on a recording material by an image output apparatus 4, (2) a regular transmission mode for transmitting, with the use of a communication device 5 to an external device, a processed image data obtained by subjecting image data read by the image input apparatus 2 to a process such as document skew correction or the like, and (3) a simple transmission mode for transmitting, with the use of the communication device 5 to an external device, (i) information that indicates a condition to be applied in drawing and that is found from image data read by the image input apparatus 2 and (ii) the image data that has not yet been subjected to image processing according to the condition. FIG. 2 shows a data flow in the image forming mode. FIG. 3 shows a data flow in the regular transmission mode and FIG. 4 shows a data flow in the simple transmission mode.

As shown in FIGS. 2 to 4, the digital color multifunction printer 1 includes the image input apparatus 2, an image processing apparatus 3, an image output apparatus 4, a communication device, 5, and an operation panel 6.

The image input apparatus 2 generates image data by reading an image of a document. The image input apparatus 2 includes a scanner section (not shown) including a device, such as a CCD (Charge Coupled Device), for converting optical information into an electric signal. In the present embodiment, the image input apparatus 2 converts an optical image reflected from the document to RGB (R: Red, G: Green, and B: Blue) analog signals, and outputs the RGB analog signals to the image processing apparatus 3.

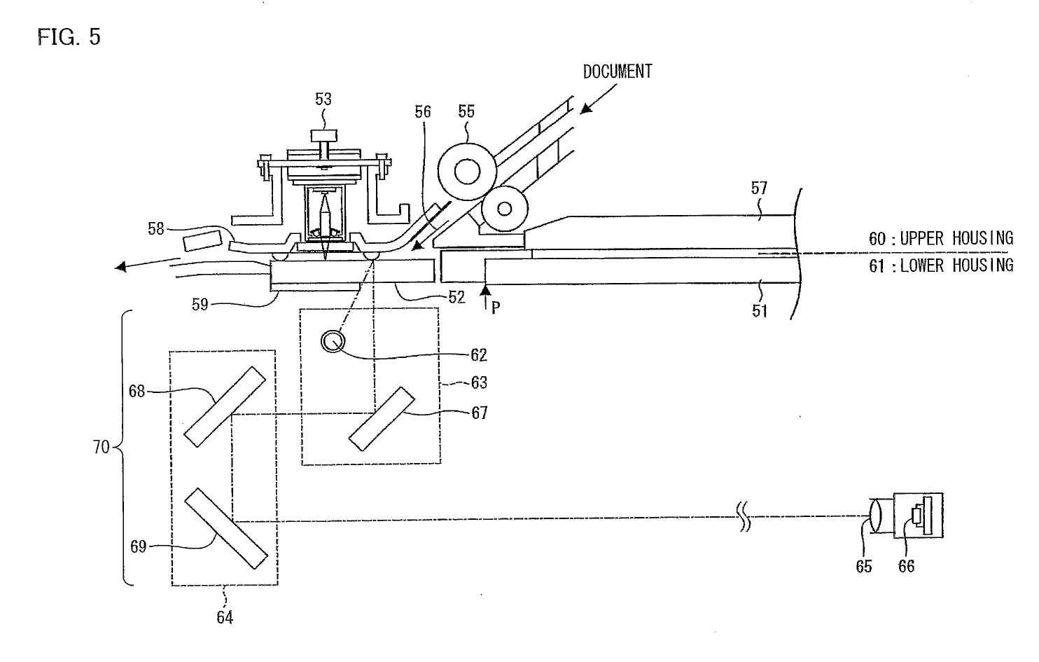

FIG. 5 is a cross sectional view illustrating one example of the image input apparatus 2. The image input apparatus 2 illustrated in FIG. 5 includes an upper housing 60 and a lower housing 61. The upper housing (document cover) 60 includes a document holder 57, a pair of alignment rollers 55, a document conveying path 56, an image sensor section 53, an upper document conveyance guide 58, and the like. The lower housing 61 includes a first contact glass (platen) 51, a second contact glass 52, a reading section 70, a light shielding member 59, and the like. The upper housing 60 is configured to be openable and closable with respect to the lower housing 61.

The image input apparatus 2 has (1) a static sheet scanning mode in which an under surface of a document placed on the first contact glass 51 is read by the reading section 70, (2) a sheet-feed reading mode in which an under surface of a document being fed (moving) on the second contact glass 52 is read by the reading section 70, and (3) a double-side reading mode in which a top surface of a document being fed (moving) on the second contact glass 52 is read by the image sensor section 53 while an under surface of this document is read by the reading section 70.

The pair of alignment rollers 55 is for aligning an angle of a document in the sheet-feed reading mode and the sheet-feed reading mode so that a front end of the document fed in becomes perpendicular to a conveyance direction. The front end of the document fed runs into a nip section of the pair of alignment rollers 55 that are not in operation and the document is bent to a predetermined degree. Then, the pair of alignment rollers 55 is rotated so as to align a direction of the document, so that the document is fed to a downstream side of the pair of alignment rollers 55.

The image sensor section 53 is for reading an image on a top surface of a document fed on the second contact glass 52 in a case where the sheet-feed reading mode is selected.

The document holder 57 is for fixing a position of a document by steadying the document placed on the first contact glass 51 against the first contact glass 51, in a case where the static-sheet scanning mode is selected.

The reading section 70 includes a first reading unit 63, a second reading unit 64, an imaging lens 65, and a CCD (Charge Coupled Device) 66.

The first reading unit 63 includes a light source (exposure lamp) 62 for exposing a document on a surface to be read, a first reflection mirror 67 for reflecting, toward the second reading unit 64, light reflected from the document.

In the static-sheet scanning mode, while moving at a constant speed V rightward from a position P in FIG. 5 in parallel to the first contact glass 51 by a distance corresponding to a document size, the first reading unit 63 exposes the document placed on the first contact glass 51 by use of light emitted from the light source 62 and lead light reflected from the document to the second reading unit 64, by reflecting the reflected light with use of the first reflection mirror 67. The document size may be a result of detecting a size of a document placed on the first contact glass 51, with use of document size detection means (not shown) (e.g., document size detection means made of a photoelectric conversion element such as a phototransistor). Alternatively, the document size may be a document size inputted by a user from an operation panel. Note that in the present embodiment, the first contact glass 51 is configured to be a size that makes it possible to read a document of up to a size of A3 (420 mm×297 mm).

In the sheet-feed reading mode and the sheet-feed reading mode, the first reading unit 63 stays at a predetermined position opposed to the second contact glass 52. At this position, the first reading unit 63 exposes the document fed on the second contact glass 52 by use of light emitted from the light source 62 and leads light reflected from the document to the second reading unit 64, by reflecting the reflected light with use of the first reflection mirror 67.

The second reading unit 64 includes a second reflection mirror 68 and a third reflection mirror 69. These reflection mirrors 68 and 69 are configured to lead, to the imaging lens 65 and the CCD 66, the light entered from the first reflection mirror 67. Note that in the static-sheet scanning mode, the second reading unit 64 moves at a speed of V/2, following the first reading unit 63.

The light shielding member 59 is for preventing the image sensor section 53 from becoming incapable of reading an image at an appropriate density, by preventing the light of the light source 62 in the reading section 70 from entering the image sensor section 53.

The imaging lens 65 forms an image on the CCD 66 from the light that is reflected from the document and that is entered from the third reflection mirror 69.

The CCD 66 converts the light entered through the imaging lens 65 into an analog electric signal. Note that this electric signal is converted to digital image data by the image processing apparatus 3 later described. Note that in the case of the sheet-feed reading mode, image data on the under surface of the document read by the reading section 70 is inputted into the image processing apparatus 3 and processed; thereafter, image data on the top surface of the document read by the image sensor section 53 is inputted into the image processing apparatus 3 and processed. While the image data on the under surface of the document is processed by the image processing apparatus 3, the image data on the top surface of the document read by the image sensor section 53 is temporarily stored in a memory (not shown). When the processing on the image data on the under surface of the document ends, the image data on the top surface of the document is read out from the memory and sent to the image processing apparatus 3 for processing.

As shown in FIGS. 2 through 4, the image processing apparatus 3 includes an A/D (Analog/Digital) conversion section 11, a shading correction section 12, an input processing section 13, a document detection section (condition detection section) 14, a document correction section 15, a color correction section 16, a black generation and under color removal section 17, a spatial filter process section 18, an output tone correction section 19, a halftone generation section 20, a segmentation process section 21, a transmission data generation section 22, a storage section 23, and a control section 24. The storage section 23 is storage means in which various data (e.g., image data) to be processed in the image processing apparatus 3 is stored. A configuration of the storage section 23 is not specifically limited. For example, a hard disk may be used as the storage section 23. The control section 24 is control means for controlling operations of each section provided in the image processing apparatus 3. This control section 24 may be provided in a main control section (not shown) of the digital color multifunction printer 1. Alternatively, the control section 24 may be provided separately from the main control section and configured to perform a process in cooperation with the main control section.

In the image forming mode, the image processing apparatus 3 outputs CMYK image data to the image output apparatus 4. This CMYK image data is obtained by performing various image processes on the image data entered from the image input apparatus 2. In the regular transmission mode, the image processing apparatus 3 performs, on the image data entered from the image input apparatus 2, image processes such as a skew correction process, an image region extraction process, a scaling process, and a rotation process. Further, in the regular transmission mode, the image processing apparatus 3 generates, in accordance with processed image data having been subjected to the image processes, R′G′B′ image data (e.g., sRGB data) that conforms to display characteristics of a commonly-used display device. Then, the image processing apparatus 3 converts the R′G′B′ image data into a predetermined format and outputs, to the communication device 5, the R′G′B′ image data in the predetermined format. In the simple transmission mode, the image processing apparatus 3 generates, in accordance with processed image data having been subjected to the image processes, R′G′B′ image data (e.g., sRGB data) that conforms to the display characteristics of a commonly-used display device. Further, the image processing apparatus 3 outputs, to the communication device 5, (i) a draw command indicative of parameters regarding a correction process, a top-to-bottom correction process, an image extraction process, and the like process each to be applied at the time when the image data is displayed by an external device and (ii) the R′G′B′ image data, after the draw command and the R′G′B′ image data are converted into a predetermined format. Note that the image processing apparatus 3 are later explained in detail.

The image output apparatus 4 outputs, onto a recording material (e.g., paper), the image data inputted from the image processing apparatus 3. A configuration of the image output apparatus 4 is not specifically limited. It is possible to use, for example, an electrophotographic or inkjet image output apparatus, as the image output apparatus 4.

The communication device 5 may be configured by, for example, a modem or a network card. The communication device 5 performs data communication with other devices (e.g., a personal computer, a server, a display device, other digital multifunction printer, and/or a facsimile machine), connected to a network, via a network card, a LAN cable, or the like. When transmitting image data, the communication device 5 performs a procedure for transmission to a destination and ensures a state transmittable to the destination. Then, the communication device 5 reads out, from a memory, the image data compressed in a predetermined format, subjects the image data to necessary processes such as a conversion in compression format, and then transmits the image data in sequence via a communication line. Further, when receiving image data, the communication device 5 performs a communication procedure and then receives image data transmitted from a source and inputs the image data into the image processing apparatus 3. The received image data is subjected to a predetermined process such as a decompression process, a rotation process, a resolution conversion process, output tone correction, and a tone reproduction process in the image processing apparatus 3, and then outputted by the image output apparatus 4. Note that the received image may be stored in a storage device (not shown), and the image processing apparatus 3 may read out the received image data from the storage device as appropriate and subjects the image data to the predetermined process.

The operation panel 6 is configured with a setup button, a display section such as a liquid crystal display, and the like (which are not shown). The operation panel 6 transmits, to the main control section (not shown) of the digital color multifunction printer 1, information inputted by a user from the setup button as well as displaying, on the display section, information corresponding to an instruction given by the main control section. The user is allowed to input, from the control panel 6, various information such as a process mode for inputted image data, the number of sheets to be printed, a sheet size, and a destination address.

The main control section is made of, for example, a CPU (Central Processing Unit) or the like, and controls, based on, for example, a program and various data which are stored in a ROM (not shown) or the like, information inputted from the operation panel 6 or the like, operations of the respective sections of the digital color multifunction printer 1.

Next, the following explains a process in each section provided in the image processing apparatus 3 in each of the modes above.

### (2) Brief Description of Processes in Image Processing Apparatus 3

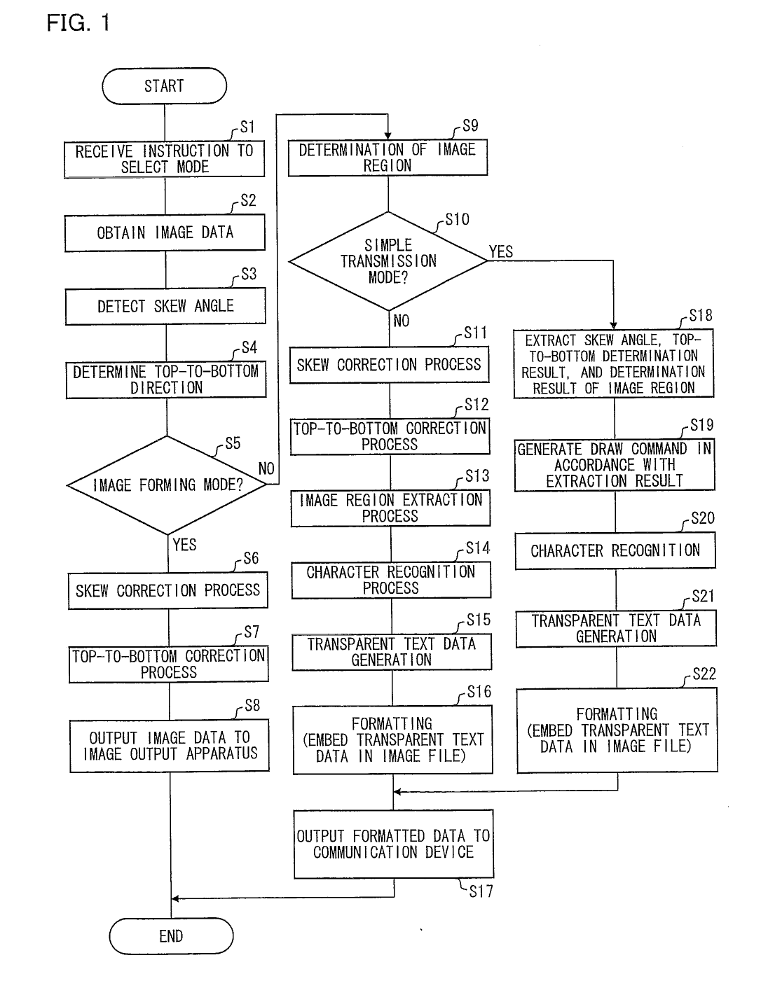

FIG. 1 is a flow chart schematically illustrating a process flow in the image processing apparatus 3. As shown in FIG. 1, first, the control section 24 receives an instruction to select a process mode from a user (S1). This instruction is inputted through the operation panel 6. Further, the control section 24 obtains, from the image input apparatus 2, image data obtained by reading a document (S2).

Then, the control section 24 causes the document detection section 14 to detect a skew angle (S3) and to determine a top-to-bottom direction (S4).
Subsequently, the control section 24 determines whether or not the process mode instructed to select in S1 is the image forming mode (S5). In a case where the control section 24 determines that the image forming mode is selected, the control section 24 causes the document correction section 15 to perform a skew correction process based on a result of detecting the skew angle in S3 (S6) and also causes the document correction section 15 to perform a top-to-bottom correction process based on a result of determining the top-to-bottom direction in S4 (S7). Consequently, the control section 24 causes the image output apparatus 4 to output the image data having been subjected to the skew correction process and the top-to-bottom correction process to the image output apparatus 4 (S8) and ends the processing.

Meanwhile, in a case where the control section 24 determines in S5 that the process mode instructed is not the image forming mode, the control section 24 causes the document detection section 14 to perform a determination process of a document image region in the image data (S9).

Further, the control section 24 determines whether or not the process mode instructed to select in S1 is a simple transmission mode (S10). Then, in a case where the control section 24 determines that the process mode instructed is not the simple transmission mode, the control section 24 determines that the process mode is the regular transmission mode. Then, the control section 24 causes the document correction section 15 to perform a skew correction process based on the result of detecting the skew angle in S3 (S11) and also causes the document correction section 15 to perform a top-to-bottom correction process based on the determination result of the top-to-bottom direction in S4 (S12). Further, the control section 24 causes the document correction section 15 to perform an image extraction process based on the determination result of the image region in S9 (S13).

The control section 24 further causes the transmission data generation section 22 (i) to perform a character recognition process (S14), (ii) to generate transparent text data based on a result of the character recognition process (S15), and then, (iii) to generate an image file obtained by formatting the image data and the transparent text data according to a predetermined format (the PDF in the present embodiment) (S16). Consequently, the control section 24 causes the transmission data generation section 22 to output the formatted image file to the communication device 5 (S17) and ends the processing.

Meanwhile, in a case where the control section 24 in S10 determines that the process mode instructed is the simple transmission mode, the control section 24 causes the transmission data generation section 22 to extract results of the skew angle detection, the top-to-bottom determination, and the determination of the image region each of which are performed by the document detection section 14 (S18). Then, the control section 24 causes the transmission data generation section 22 to generate, based on these results extracted, a draw command to be applied at the time when the image data is displayed by the external device (S19). Further, the control section 24 causes the transmission data generation section 22 to perform a character recognition process (S20) and to generate transparent text data based on a result of the character recognition process (S21). Then, the control section 24 controls the transmission data generation section 22 so as to cause the transmission data generation section 22 to generate an image file obtained by formatting the image data, the draw command, and the transparent text data in accordance with a predetermined format (the PDF in the present embodiment) (S22). Consequently, the control section 24 causes the transmission data generation section 22 to output, to communication device 5, a formatted image file (S17) and ends the processing.

### (3) Image Foaming Mode

The following explains in detail an operation of the image forming apparatus 3 in the image forming mode. In the image forming mode, as shown in FIG. 2, first, the A/D conversion section 11 converts the RGB analog signals inputted from the image input apparatus 2 into digital signals and outputs the digital signals to the shading correction section 12.

The shading correction section 12 receives the digital RGB signals from the A/D conversion section 11 and subjects the digital RGB signals to a process for removing various distortions produced in an illumination system, an image-focusing system and an image-sensing system of the image input apparatus 2. Then, the shading correction section 12 outputs the processed digital RGB signals to the input processing section 13.

The input processing section (input tone correction section) 13 adjusts a color balance of the RGB signals from which various distortions are removed in the shading correction section 12, and simultaneously converts the RGB signals to signals, such as density signals, easy to handle for in the image processing apparatus 3. Further, the input processing section 13 also performs removal of background density and adjustment of image quality such as contrast. The input processing section 13 also stores the image data processed as described above into the storage section 23.

The document detection section (condition detection section) 14 detects, based on image data, a skew angle of a document image, a top-to-bottom direction, an image region that is a region where an image is present in the image data, and the like. The document correction section 15 performs a skew correction process, a top-to-bottom direction correction process, an image extraction process, and the like process on the image data, based on the results of the detection by the document detection section 14.

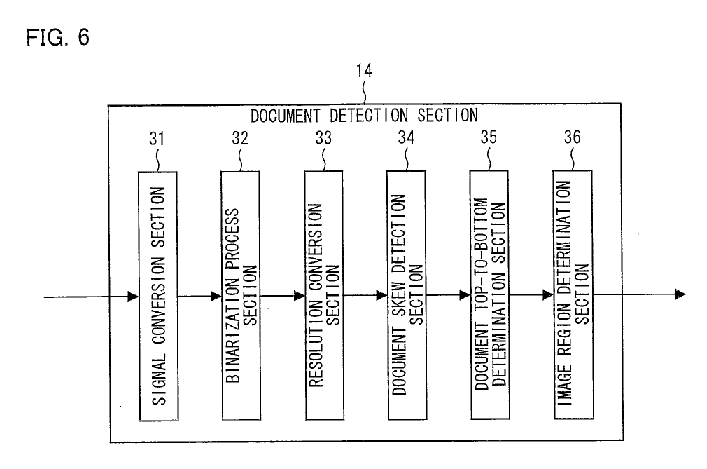

FIG. 6 is a block diagram schematically illustrating a configuration of the document detection section 14. As shown in FIG. 6, the document detection section 14 includes a signal conversion section 31, a binarization process section 32, a resolution conversion section 33, a document skew detection section 34, a document top-to-bottom determination section 35 and an image region determination section 36.

In a case where the image data having been subjected to the processes above by the input processing section 13 is color image data, the signal conversion section 31 converts the color image data into a brightness signal or a luminance signal (monochrome image data).

For example, the signal conversion section 31 converts the RGB signals to a luminance signal Y by calculating Yi=0.30 Ri+0.59 Gi+0.11 Bi, where: Y is a luminance signal of each pixel; R, G, and B are respective color components of the RGB signals of each pixel; and a subscript i is a value (i is an integer equal to or greater than 1) given to each pixel.

Alternatively, the RGB signals may be converted to a CIE1976L*a*b* signal (CIE: Commission International de l'Eclairage, L*: Brightness, a* and b*:chromaticity).

The binarization process section 32 binarizes the image data by comparing the monochrome image data (luminance value (luminance signal) or brightness value (brightness signal)) with a predetermined threshold. For example, in a case where the image data is an 8-bit image data, the threshold is set to 128. Alternatively, an average value of densities (pixel values) in a block made of a plurality of pixels (e.g., 5 pixels×5 pixels) may be set as the threshold.

The resolution conversion section 33 converts a resolution of the binarized image data to a low resolution. For example, image data read at 1200 dpi or 600 dpi is converted to image data of 300 dpi. A conversion method of the resolution is not specifically limited. It is possible to use, for example, a conventionally known method such as a nearest neighbor method, a bilinear method, and a bicubic method.

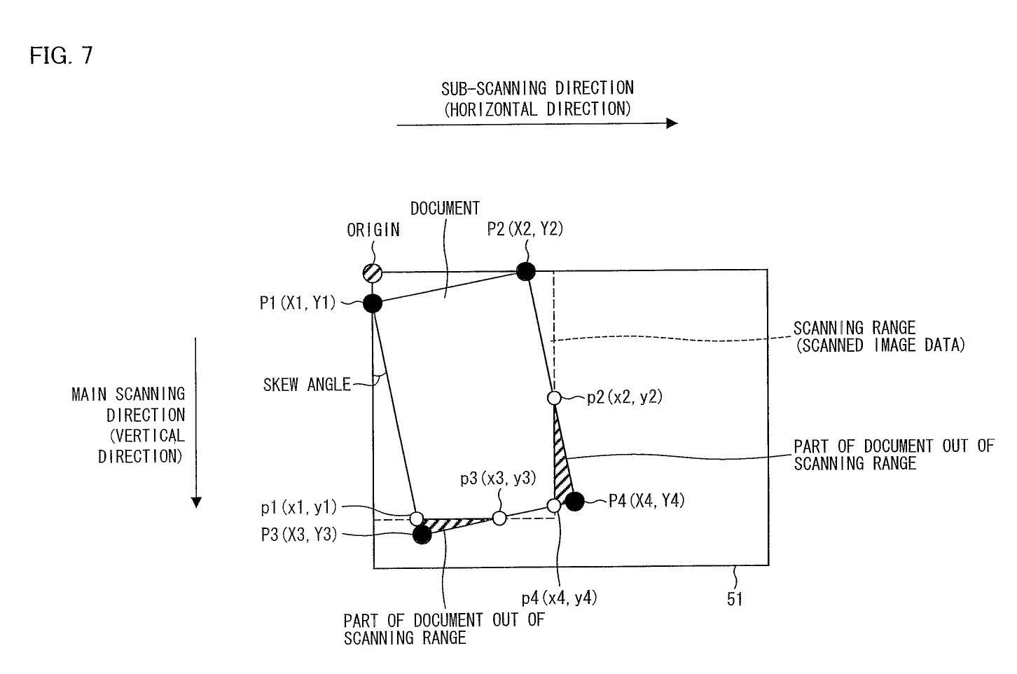

The document skew detection section 34 detects a skew angle of a document with respect to a reading range (regular document orientation) in image reading, based on the image data whose resolution is converted to a low resolution by the resolution conversion section 33. That is, in a case where, as shown in FIG. 7, an orientation of the document in image reading is skewed with respect to a reading range (regular document orientation) in the image input apparatus 2, the document skew detection section 34 detects the skew angle.

A method of detecting the skew angle is not specifically limited. However, various conventionally known methods can be used. For example, a method described in Patent Literature 4 may be used. In this method, a plurality of boundary points between black pixels and white pixels (e.g., coordinates of black/white boundary points of an upper edge of each text) are extracted from the binarized image data, and coordinate data of a line of points for the boundary points is obtained. Then, based on the coordinate data of the line of points, a regression line is obtained and a regression coefficient b of the regression line is calculated according to the formula (1) below:

b=Sxy/Sx (1)

Note that: Sx is an error sum of squares of a variable x and Sy is an error sum of squares of a variable y; and Sxy is a sum of products each obtained by multiplying a residual of x by a residual of y. In other words, Sx, Sy and Sxy are represented by the following formulae (2) to (4):

$$\begin{matrix}Sx = {\sum }_{i = 1}^{n} {( {x}_{i} - x )}^{2} = {\sum }_{i = 1}^{n} {x}_{i}^{2} - {( {\sum }_{i = 1}^{n} {x}_{i} )}^{2} / n & ( 2 ) \\ Sy = {\sum }_{i = 1}^{n} {( {y}_{i} - y )}^{2} = {\sum }_{i = 1}^{n} {y}_{i}^{2} - {( {\sum }_{i = 1}^{n} {y}_{i} )}^{2} / n & ( 3 ) \\ Sxy = {\sum }_{i = 1}^{n} ( {x}_{i} - x ) ( {y}_{i} - y ) = {\sum }_{i = 1}^{n} {x}_{i} {y}_{i} - ( {\sum }_{i = 1}^{n} {x}_{i} ) ( {\sum }_{i = 1}^{n} {y}_{i} ) / n & ( 4 )\end{matrix}$$

Further, by using the regression coefficient b calculated as described above, a skew angle θ is calculated according to the following formula (5):

tan θ=b (5)

Further, the document skew detection section 34 detects an edge section of the document, and calculates respective coordinates P1 (X1, Y1), P2 (X2, Y2), P3 (X3, Y3), and P4(X4, Y4) of corner sections of the document. Note that, as shown in FIG. 7, even in a case where a corner section of the document is not present in a range of the image data, the coordinates of the corner section is calculated based on detection results of the edge section of the document and the skew angle.

In the present embodiment, first, calculation is performed for each line unit in a sub-scanning direction, for obtaining coordinates of the rightmost pixel and the leftmost pixel as edge coordinates among pixels that are processing pixels (target pixels, pixels of interest) each of which has a pixel value that is different from a pixel value of an adjacent pixel by more than a predetermined threshold value (e.g., 40), regarding the image data read by the image input apparatus 2. Next, among the edge coordinates for all the lines of the image data, edge coordinates that become top, bottom, leftmost, and rightmost coordinates are extracted.

In an example of FIG. 7, the following coordinates are extracted as the edge coordinates that are the top, bottom, leftmost and rightmost coordinates.

### Top: P2 (X2, Y2)

Bottom: p1 (x1, y1) and p3 (x3, y1), where note that x1<x3

### Left: P1 (X1, Y1)

Right: p2 (x2, y2) and p4 (x2, y4), where note that y2<y4

In a case where two points (two sets of coordinates) are extracted in this way for any one of the top, bottom, leftmost and rightmost coordinates, coordinates that are coordinates of a corner section of the document and that present at a position out of a reading range is calculated according to a line connecting the two points extracted and the coordinates extracted for other section.

More specifically, in the case of FIG. 7, the following lines are found: a line connecting the points P1 and p1; a line connecting the points P2 and p2; and a line connecting the points p3 and p4. Then, calculation is performed for obtaining (i) as P3, an intersection of the line connecting the points P1 and p1 and the line connecting the points p3 and p4 and (ii) as P4, an intersection of the line connecting the points P2 and p2 and the line connecting the points p3 and p4.

Alternatively, the coordinates of the respective corner sections P1 to P4 may be obtained as follows. First, the number of pixels between P1 and P2 and the number of pixels between P1 and p3 are obtained. Then, a size of the document is estimated based on a relation between resolutions and the numbers of pixels in vertical and horizontal directions of a regular-size document. This relation is stored in advance (See Table 1, for example). Then, the coordinates of the respective corner sections P1 to P4 are calculated based on a result of the estimation.

TABLE 1

Number of Pixels

| | Vertical (Main | Horizontal (Sub- | Document |
|---|---|---|---|
| Sheet | Scanning | scanning | Placement |
| Size | Direction) | Direction) | Orientation |
| A3 | 297 × R1/25.4 | 420 × R2/25.4 | Horizontal |
| A4 | 210 × R1/25.4 | 297 × R2/25.4 | Horizontal |
| | 297 × R1/25.4 | 210 × R2/25.4 | Vertical |
| A5 | 148 × R1/25.4 | 210 × R2/25.4 | Horizontal |
| | 210 × R1/25.4 | 148 × R2/25.4 | Vertical |
| B4 | 257 × R1/25.4 | 364 × R2/25.4 | Horizontal |
| B5 | 182 × R1/25.4 | 257 × R2/25.4 | Horizontal |
| | 257 × R1/25.4 | 182 × R2/25.4 | Vertical |

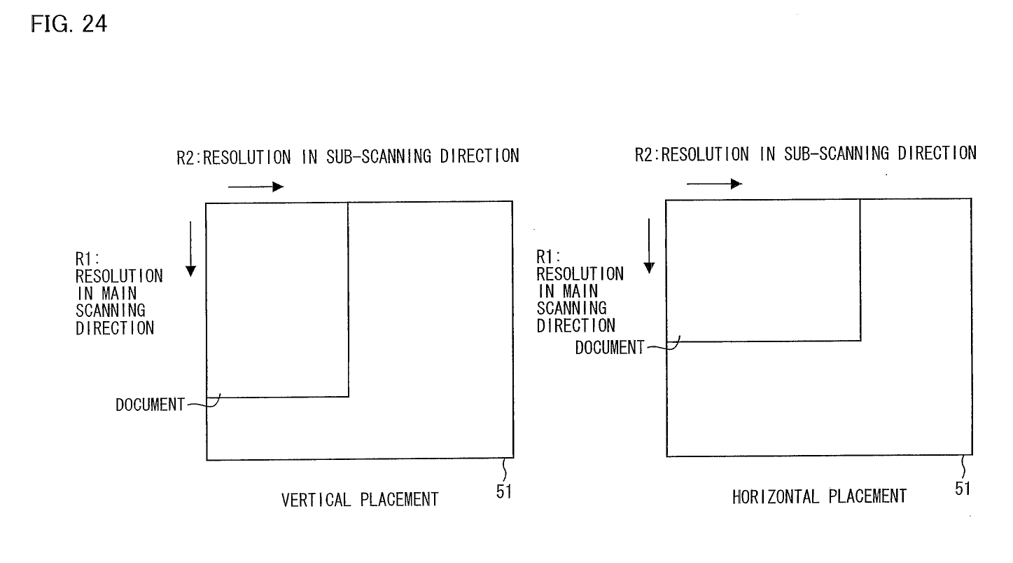

Note that in Table 1, as shown in FIG. 24, a case where the document is placed such that a short side of the first contact glass (platen) 51 is substantially parallel to a long side of the document is defined as a horizontal placement; whereas a case where the document placed such that a short side of the first contact glass (platen) 51 is substantially parallel to a short side of the document is defined as a vertical placement. Further, R1 in Table 1 indicates a scanning resolution in the main scanning direction (a direction along the short side of the first contact glass (platen) 51); whereas R2 in Table 1 indicates a scanning resolution in the sub-scanning direction (a direction along a long side of the first contact glass (platen) 51).

Further, in consideration of variation or the like in calculating edges of a document, a range of the document image may be calculated so as to be wider by a predetermined width (e.g., approximately 10 mm) than a result of edge detection.

Further, the image input apparatus 2 may read a wider area than an area of a document having a maximum size for which the image input apparatus 2 can perform reading. This is for allowing the image input apparatus 2 to read a whole document even in a case where the document is placed on the platen in a skewed state. For example, in the case of the example shown in FIG. 7, the image input apparatus 2 may be configured to read, in the main scanning direction, all range of a width of the platen in a vertical direction and to read, in the sub-scanning direction, a range corresponding to a length of a long side of an A3 size sheet that is the maximum size for which the image input apparatus 2 can perform reading. Alternatively, the image input apparatus 2 may be configured to read whole ranges of the platen in both the main scanning direction and the sub-scanning direction.

The document top-to-down determination section 35 determines a top-to-bottom direction (upper and lower directions) of the document, based on the image data which is binarized by the binarization process section 32 and whose resolution is converted to a low resolution by the resolution conversion section 33.

Note that the top-to-bottom determination process may be performed as follows. That is, first, the document correction section 15 subjects the image data to a skew correction process, based on a detection result of the document skew detection section 34. Then, with respect to the image data whose skew is corrected, the signal conversion section 31 performs a signal conversion process; the binarization process section 32 performs a binarization process, and the resolution conversion section 33 performs a resolution conversion process. Subsequently, the document top-to-bottom determination section 35 may perform the top-to-bottom determination based on the image data obtained by subjecting the image data whose skew is corrected to the signal conversion process, the binarization process, and the resolution conversions process.
The determination method of the top-to-bottom direction of the document is not specifically limited, but various conventionally known method may be used. For example, a method described in Patent Literature 5 may be used.

According to the method of Patent Literature 5, the character recognition process is performed based on the image data and characters in the document are clipped one by one so that a pattern is developed for each character. Note that this process is performed by using the binarized image data whose resolution is reduced to 300 dpi. The character recognition process is not necessarily performed for all the characters. For example, for example, the character recognition process may be performed on a predetermined number of characters extracted.

Subsequently, a characteristic of the character pattern is matched (compared) with character pattern information for which a database is compiled. A matching method may be configured as follows. That is, the character pattern clipped from the image data is superimposed on the character pattern for which a database is compiled, and black and white are compared for each pixel. Then, the character in the image data is determined to be a character of the character pattern to which all pixels match, among character patterns for each of which a database is compiled. Note that in a case there is no character pattern to which all pixels match, a character in the image data is determined to be a character of a character pattern with which the largest number of pixels match. However, unless a ratio of the number of pixels that match to a character pattern does not reach a predetermined matching ratio, it is determined that the determination is impossible.

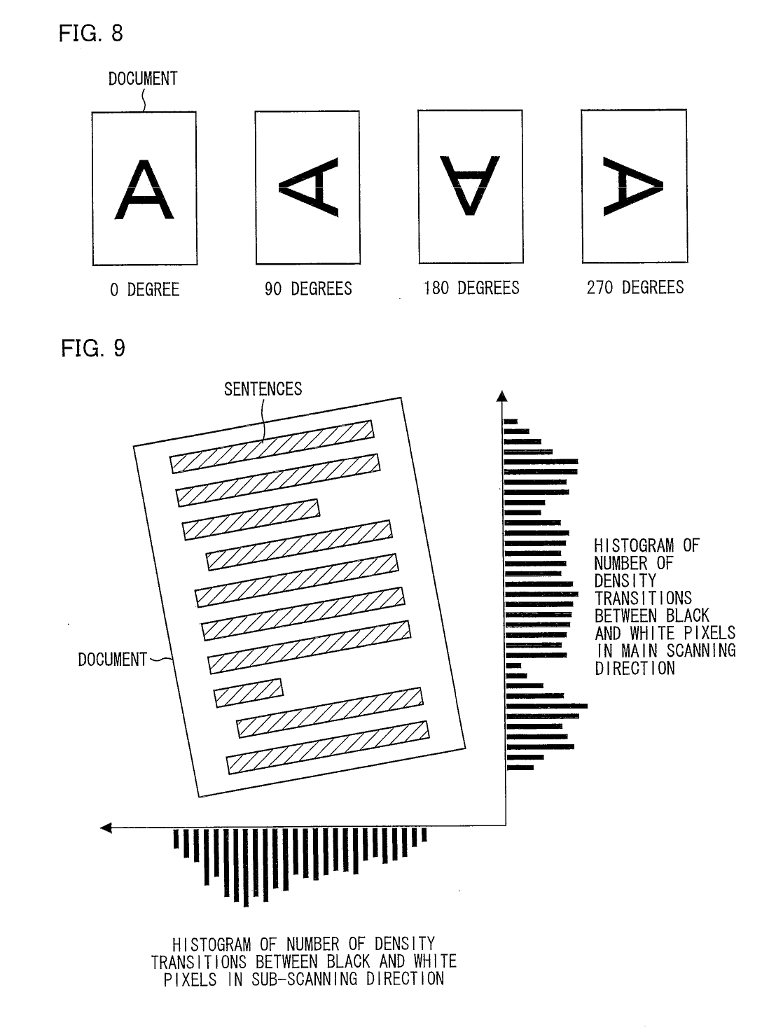

The character recognition process is performed for each of cases where the image data is rotated by 90°, 180°, and 270°. Then, for each of the cases where the image data is rotated by 0°, 90°, 180°, and 270°, the number of determinable characters is calculated. Then, a rotation angle which has the largest number of determinable characters is determined to be a regular top-to-bottom direction of the document. Further, a rotation angle is determined for coincide the top-to-bottom direction of the document image in the image data with the regular top-to-bottom direction. More specifically, on an assumption that an angle in a clockwise direction with respect to the regular top-to-bottom direction is a positive angle, as shown in FIG. 8, the rotation angles are defined as follows: (i) 0° in a case where the top-to-bottom direction (reference direction) of the document image in the image data coincides with the regular top-to-bottom direction; (ii) 90° in a case where the top-to-bottom direction of the top-to-bottom direction by −90°; (iii) 180° in a case where the top-to-bottom direction of the document image in the image data differs from the regular top-to-bottom direction by −180°; and (iv) 270° in a case where the top-to-bottom direction of the document image in the image data differs from the regular top-to-bottom direction by −270°.
The image region determination section 36 determines an image region (a region where an image is drawn) in the image data which is binarized by the binarization process section 32 and whose resolution is reduced by the resolution conversion section 33, and outputs a result of the determination to the document correction section 15.

A determination method of the image region is not specifically limited, but conventionally known various methods can be used. For example, the determination method may be such that: as shown in FIG. 9, a histogram is

made in regard to the number of density transitions between black and white pixels for each of the main scanning direction and the sub-scanning direction; and then, based on this histogram, coordinates of image data present at the leftmost, the rightmost, the top and the bottom are determined.

The document correction section 15 subjects the image data to the skew correction process, based on the skew angle detection result obtained by the document skew detection section 34. In this skew correction process, in a case where, as shown by a shaded area in FIG. 7, a part of the document is out of the image data, that is, in a case where a part of the document is out of a reading range, this part out of the image data is replaced by a predetermined color (e.g., white (255 in the case of 8-bit image data)).

Further, based on the determination result obtained by the document top-to-bottom determination section 35, a top-to-bottom correction process (rotation process by a unit of) 90° is performed on the image data having been subjected to the skew correction process so that the top-to-bottom direction of the image data coincides with the top-to-bottom direction of the document image included in the image data. The document correction section 15 subjects the image data on which the skew correction process and the top-to-bottom correction process are performed, to an image extraction process for extracting image data corresponding to the image region determined by the image region determination section 36 and a scaling process (enlarging/reducing process) for converting a size of the extracted image data into a predetermined size (e.g., a size corresponding a size of a recording material used in the image output apparatus 4). Further, the document correction section 15 outputs, to the color correction section 16 and the segmentation process section 21, the image data having been subjected to the above processes.

Note that the image data having been subjected to the above processes by the document correction section 15 may be handled as filing data. In such a case, the image data is stored in the storage section 23 after compressed into a JPEG code according to a JPEG compressing algorithm. In a case where a copy output operation and/or a print output operation directed to the image data is instructed, the JPEG code is taken out from the storage section 23 and transferred to an JPEG decoding section (not shown). Subsequently, the JPEG code is subjected to a decoding process and converted to RGB data. Further, in a case where a transmission operation directed to the image data is instructed, the JPEG code is taken out from the storage section 23 and transmitted from the communication device 5 to an external device via a network or a communication line.

The color correction section 16 is for performing color correction to the RGB data so as to make color production accurate. In the color correction, color impurity is removed in accordance with spectral characteristics of a CMY (C: Cyan, M: Magenta, and Y: Yellow) color material containing an unnecessary absorption component.

The black generation and under color removal section 17 is for performing black generation in which a black (K) signal is generated from color-corrected three color signals of CMY, and subtracts the K signal from the original CMY signals so as to generate new CMY signals. In this way, the three color signals of CMY are converted into four-color signals of CMYK.

The spatial filter process section 18 is for performing in accordance with the segmentation class signal the spatial filter process (edge enhancement process and/or smoothing process) by a digital filter, with respect to image data of the CMYK signals supplied from the black generation and under color removal section 17, so that a spatial frequency characteristic of the image data is corrected. This makes it possible to reduce a blur or a granularity deterioration of an output image.

In a similar manner to the spatial filter process section 18, the halftone generation section 20 performs, in accordance with the segmentation class signal, a predetermined process with respect to the image data of the CMYK signals. For example, in a region segmented into a text by the segmentation process section 21, a high frequency component is strongly sharpened by the spatial filter process performed by the spatial filter process section 18, for improvement in reproducibility of, particularly, a black text or a color text. At the same time, the halftone generation section 20 selects a binarization or multi-level dithering process in a high-resolution screen which is suitable for reproduction of the high-frequency component. Furthermore, on a region segmented into a halftone dot region by the segmentation process section 21, the spatial filter process section 18 performs a low-pass filter process for removing an input halftone dot component. Then, the output tone correction section 19 performs an output tone correction process for converting a signal, such as a density signal, to a halftone dot area ratio which is a characteristic value used by the image output apparatus 4. Subsequently, image is finally segmented into pixels by the halftone generation section 20, and then the image is subjected to a tone reproduction process (halftone generation) for reproducing each tone of the pixels. On a region segmented into a photograph region by the segmentation process section 21, a binarization or multi-level dithering process is performed by use of a screen suitable for tone reproduction.

The segmentation process section 21 performs, in accordance with the RGB signals, segmentation of each pixel of an input image into any one of a black text region, a color text region, a halftone dot region, and a photograph region (continuous tone image region). According to a result of the segmentation, the segmentation process section 21 outputs a segmentation class signal indicative of a region to which a pixel belongs, to the black generation and under color removal section 17, the spatial filter process section 18, and the halftone generation section 20.

The transmission data generation section 22 includes an information extraction section 41, a character recognition section 42, a draw command generation section 43, and a formatting process section 44. Note that the transmission generation section 22 does not operate in the image forming mode. The transmission data generation section 22 is later explained in detail.

The image data having been subjected to the processes described above is temporarily stored in a memory (not shown). Then, the image data stored is read out at a predetermined timing and inputted into the image output apparatus 4.

### (4) Regular Transmission Mode (Regular Mode)

The following explains in more detail an operation of the image processing apparatus 3 in the regular transmission mode, with reference to FIG. 3. Note that the respective processes performed by the A/D conversion section 11, the shading correction section 12, the input processing section 13, the document correction section 15, and the segmentation process section 21 are the same as those in the image forming mode. Note that the segmentation process section 21 outputs a segmentation class signal to the spatial filter process section 18 and the halftone generation section 20.

The document detection section 14 operates in the same manner as that in the image forming mode, and also outputs, to the transmission data generation section 22, the binarized image data whose resolution is reduced.

The color correction section 16 converts, into R′G′B′ image data (e.g., sRGB data), the RGB image data inputted from the document correction section 15. The R′G′B′ image data conforms to the display characteristics of a commonly-used display device. Then, the color correction section 16 outputs the R′G′B′ image data to the black generation and under color removal section 17. In the regular transmission mode, the black generation and under color removal section 17 directly outputs (without subjecting the image data to any process), to the spatial filter process section 18, the image data inputted from the color correction section 16.

The spatial filter process section 18 performs, by a digital filter, a spatial filter process (edge enhancement process or smoothing process) on the R′G′B′ image data inputted from the black generation and under color removal section 17, in accordance with the segmentation class signal, and outputs the processed R′G′B′ image data to the output tone correction section 19. In the regular transmission mode, the output tone correction section 19 directly outputs (without subjecting the processed R′G′B′ image data to any process), to the halftone generation section 20, the processed R′G′B′ image data inputted from the spatial filter process section 18.

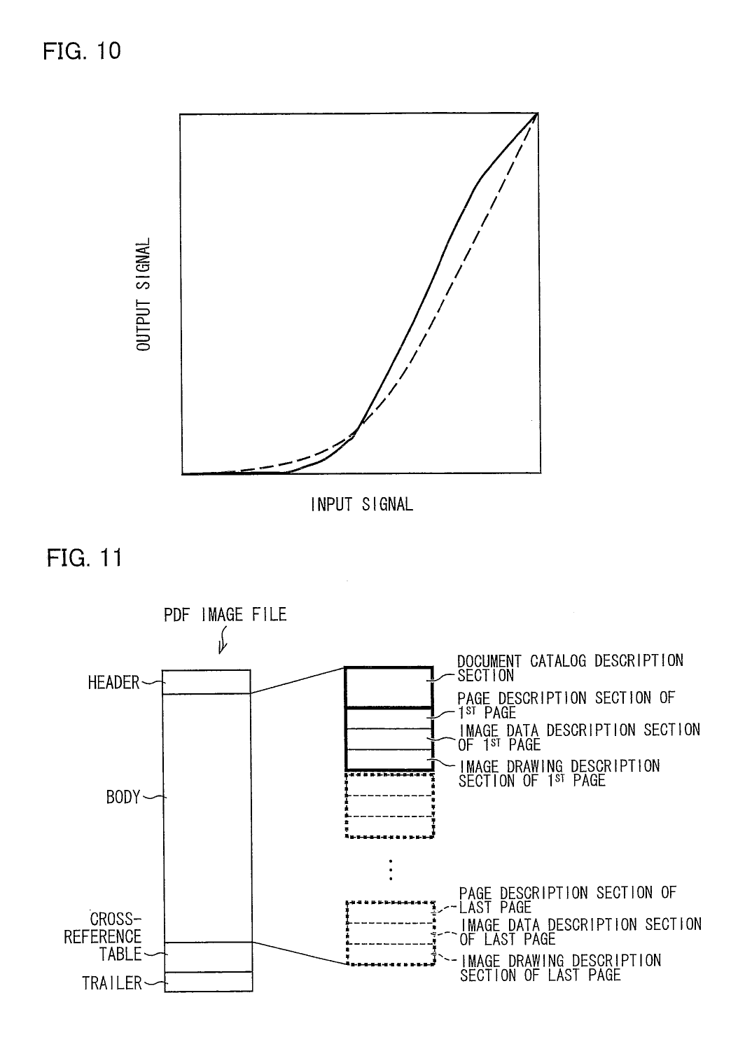

The halftone generation section 20 performs a predetermined process on the R′G′B′ image data inputted from the output tone correction section 19, in accordance with the segmentation class signal, and then outputs the processed R′G′B′ image data to the transmission data generation section 22. For example, the halftone generation section 20 performs, on the text region, correction using a gamma curve as shown by a solid line in FIG. 10, and performs, on a non-text region, correction using a gamma curve as shown by a dotted line in FIG. 10. It is preferable, for example, to set: (i) for non-text regions, a gamma curve corresponding to display characteristics of an image display device provided to the external device of the destination; and (ii) for the text region, a gamma curve for texts to be sharply displayed.

The R′G′B′ image data outputted from the halftone generation section 20 is inputted into the formatting process section 44 of the transmission data generation section 22.

The transmission data generation section 41 of the image extraction section 22 directly outputs (without subjecting the image data to any process), to the character recognition section 42, the image data inputted from the document detection section 14.

The character recognition section 42 extracts features of the text included in the image data, in accordance with the image data inputted from the information extraction section 41. Then, the character recognition section 41 performs character recognition by comparing a result the extraction with features of characters included in dictionary data. The method of the character recognition process is not specifically limited but various conventionally known method may be used.

The character recognition process may be performed as follows: as shown by a dotted line in FIG. 3, the document detection section 14 outputs the binarized image data whose resolution is reduced, not to the transmission data generation section 22 but to the document correction section 15; then, the document correction section 15 subjects, to the skew correction process, the binarized image data whose resolution is reduced, and outputs the image data having been subjected to the skew correction process to the transmission data generation section 22; and subsequently, the character recognition section 42 of the transmission data generation section 22 performs the character recognition process by using the image data having been subjected to the skew correction. This makes it possible to improve accuracy of the character recognition, as compared with a case where the character recognition is performed by using the image data that has not been subjected to the skew correction.

The draw command generation section 43 generates transparent text data, in accordance with a character recognition result obtained by the character recognition section 42, and outputs the transparent text data to the formatting process section 44. Here, the transparent text data is data to be superimposed on (or embedded into) the image data so as to appear invisible. This data allows recognized characters to be superimposed as text information. For example, in the case of a PDF file, an image file in which the transparent text data is added to the image data is typically used.

The formatting process section 44 generates an image file of a predetermined format, in accordance with image data inputted from the halftone generation section 20 and the transparent text data generated by the draw command generation section 43, and outputs the image file generated to the communication device 5. In the present embodiment, the image data (R′G′B′ image data) that has been subjected to image processing for display and that is inputted from the halftone generation section 20 is converted into PDF data, and the transparent text data generated based on the character recognition result is embedded into an image drawing description section (command description section) of each image file. The image file is later explained in detail.

Note that, though the transparent text data is added to the image data and then the image data is transmitted in the present embodiment, the configuration of the present invention is not limited to this. For example, the formatting process section 44 may transmit the image data which is inputted from the halftone generation section 20, after converting the image data into a predetermined format but not adding the transparent text data to the image data. In a case where the transparent text data is not added, data output from the document detection section 14 to the transmission data generation section 22 is not necessary.

The communication device 5 transmits, to an external device communicably connected via a network, the image file that is inputted from the formatting process section 44. For example, the communication device 5 attaches the image file to an e-mail by using a mail process section (job device) (not shown) and transmits the image file.

### (5) Simple Transmission Mode (Simple Mode)

The following explains an operation of the image processing apparatus 3 in the simple transmission mode, with reference to FIG. 4. Note that the respective processes performed by the A/D conversion section 11, the shading correction section 12, the input processing section 13, the document detection section 14, the color correction section 16, the black generation and under color removal section 17, the spatial filter process section 18, the output tone correction section 19, the halftone generation section 20, and the segmentation process section 21 are the same as those in the regular transmission mode.

The document detection section 14 transmits, to the transmission data generation section 22, the binarized image data whose resolution is reduced, the skew angle detection result, the determination result of the top-to-down direction, and the determination result of the image region. The document detection section 14 also directly outputs, to the document correction section 15, the RGB image data inputted from the input processing section 13. Alternatively, the document detection section 14 may be configured to store, in the storage section 23, the RGB image data inputted from the input processing section 13 and the document correction section 15 is configured to read out the image data from the storage section 23.

The document correction section 15 directly outputs (without subjecting the RGB image data to any process) the RGB image data to the color correction section 16 and the segmentation process section 21. That is, in the simple transmission mode, the document correction section 15 does not perform, on the RGB image data, the skew correction process, the top-to-bottom correction process, and the image extraction process.

The information extraction section 41 of the transmission data generation section 22 extracts, for each document, information indicative of the skew angle detection result, the determination result of the top-to-bottom direction, and the determination result of the image region, from the data inputted from the document detection section 14. Then, the information extraction section 41 outputs, to the character recognition section 42, the information together with the binarized image data whose resolution is reduced.

The character recognition section 42 performs the character recognition process, based on the image data inputted from the information extraction section 41, and outputs, to the draw command generation section 43, the character recognition result, the skew angle detection result, the determination result of the top-to-bottom direction, and the determination result of the image region.
The draw command generation section 43 generates a draw command in accordance with the character recognition result, the skew angle detection result, the determination result of the top-to-bottom direction, and the determination result of the image region which are inputted from the character recognition section 42, and outputs the draw command to the formatting process section 44. The draw command is for causing a computer included in an external device of a destination to execute the skew correction process, the top-to-bottom correction process, and the image extraction process and to display the image data outputted from the halftone generation section 20. The draw command generation section 43 also generates the transparent text data, in accordance with the character recognition result obtained by the character recognition section 42, and outputs the transparent text data to the formatting process section 44.

The formatting process section 44 generates an image file of a predetermined format, based on the image data inputted from the halftone generation section 20, the draw command generated by the draw command generation section 43, and the transparent text data, and outputs the image file to the communication device 5. In the present embodiment, the formatting process section 44 converts, into PDF image data, the image data that has been subjected to image processing for display and that has been inputted from the halftone generation section 20. The formatting process section 44 also generates an image file which is obtained by embedding the draw command and the transparent text data which are generated by the draw command generation section 43 into the image drawing description section (command description section) corresponding to each image data.

FIG. 11 is an explanatory diagram illustrating a configuration of a PDF image file generated by the formatting process section 44. As shown in FIG. 11, the image file is includes a header section, a body section, a cross-reference table, and a trailer section.

The header section includes a version number and a text string indicating that the file is a PDF file. The body section includes, for example, information to be displayed and page information. The cross-reference table includes a description of address information for making an access to contents of the body section. The trailer section includes a description of, for example, information indicating where to start reading.

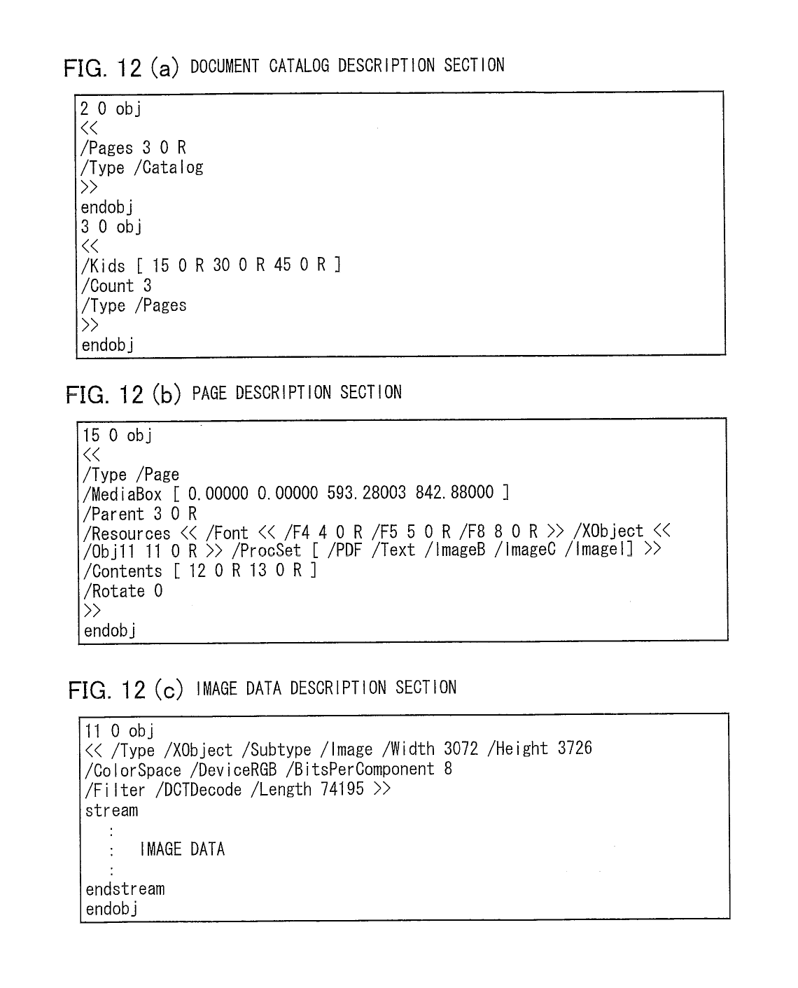

The body section is made of a document catalogue description section, a page description section, an image data description section, and the image drawing description section (the command description section). Note that the page description section, the image data description section, and the image drawing description section are provided so as to correspond to each page.
The document catalogue description section includes a description of, for example, reference information with respect to an object constituted by each page. FIG. 12(a) shows an example of description contents in the document catalogue section. The page description section has a description of, for example, a display range for each page. FIG. 12(b) shows an example of description contents in the page description section. In the example shown in FIG. 12(b), the description “/MediaBox [0.00000 0.00000 593.28003 842.88000]” defines a display range. In the image data description section, image data is described. FIG. 12(c) shows an example of description contents in the image data description section. The image drawing description section has a description of conditions to be applied at the time when a corresponding page is drawn. In the present embodiment, the image drawing description section is configured to include description of the draw command regarding the skew correction process, the top-to-bottom correction process, and the image extraction process.

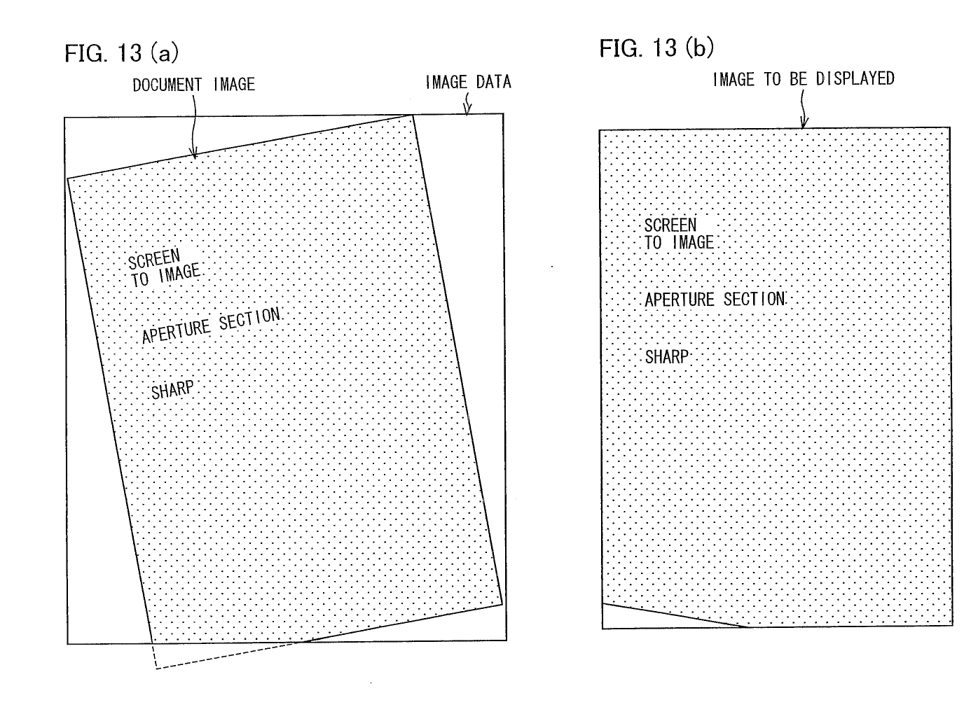

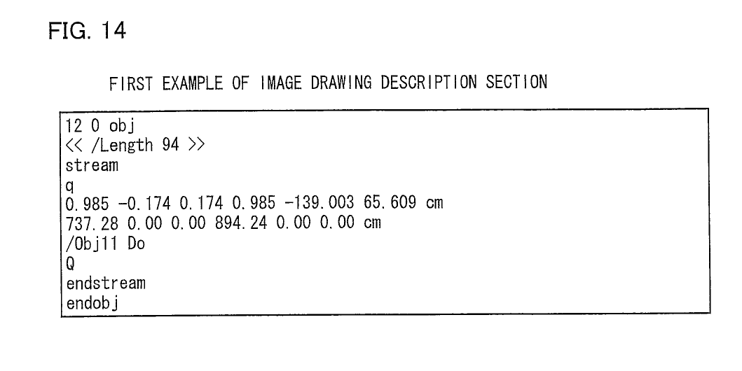

FIG. 13(a) shows an example of image data read by the image input apparatus 2. FIG. 14 shows an example of description contents in the image drawing description section and illustrates conditions to be applied at the time when the image data shown in FIG. 13(a) is drawn. In the example shown in FIG. 14, a section “0.985-0.174 0.174 0.985-139.003 65.609 cm” indicates contents regarding the skew correction and a parallel displacement process. According to the contents, the rotation process (skew correction process) by ten degrees in a clockwise direction is performed, and parallel displacement is performed so as to coincide coordinates of a lower-left corner section of the document image with coordinates (origin) of a lower-left corner section of the image to be displayed. The description “737.28 0.00 0.00 894.24 0.00 0.00 cm” indicates a display setting corresponding to an image size and an image resolution. This allows an image to be displayed in a desired size. FIG. 13 (b) shows an image to be displayed in a case where the image is drawn by applying the conditions in FIG. 14 to the image data of FIG. 13(a). In this example, though a process of extracting a region of a document image is not performed, a display area of a page is set to the same size as a size of the document and as a result, an image of a size corresponding to the size of the document is displayed. Further, in this example, because the lower left section of the document is not included in a reading range of the image input apparatus 2 and the image data does not exist, the lower left section is white in the display.

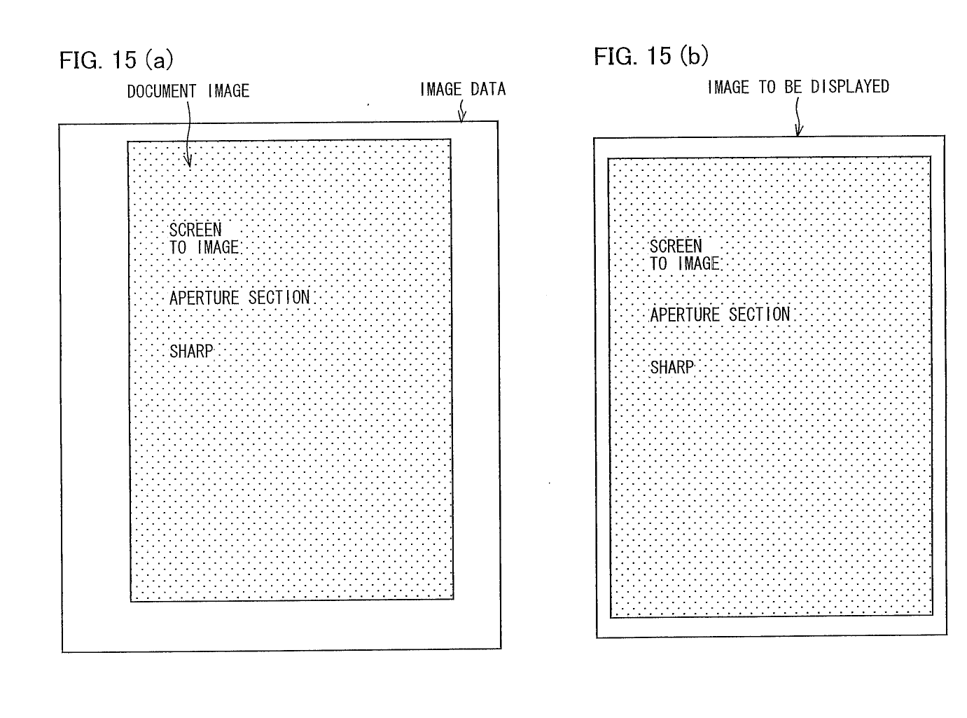

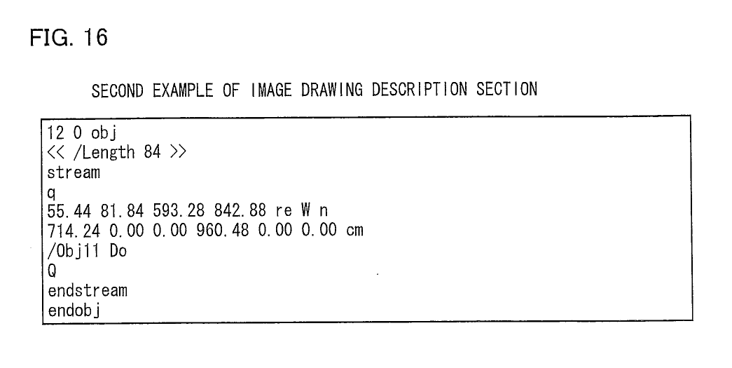

FIG. 15(a) shows an example of image data read by the image input apparatus 2. FIG. 16 shows an example of description contents in the image drawing description section and illustrates conditions to be applied at the time when the image data shown in FIG. 15(a) is drawn. In the example shown in FIG. 16, a region of the document image (document image region) is extracted from the image data and only an image in the region extracted is to be displayed. The description “55.44 81.84 593.28 842.88 re W n” in FIG. 16 indicates contents of an extraction process of the document image region. In the example shown in FIG. 16, the description defines coordinates of a left bottom, and a horizontal width and a height of the extracted rectangular region. FIG. 15(b) shows an image to be displayed in a case where the conditions of FIG. 16 is applied to the image data of FIG. 15(a). As shown in FIG. 15(b), a region out of the range of the document image region is white in the display.

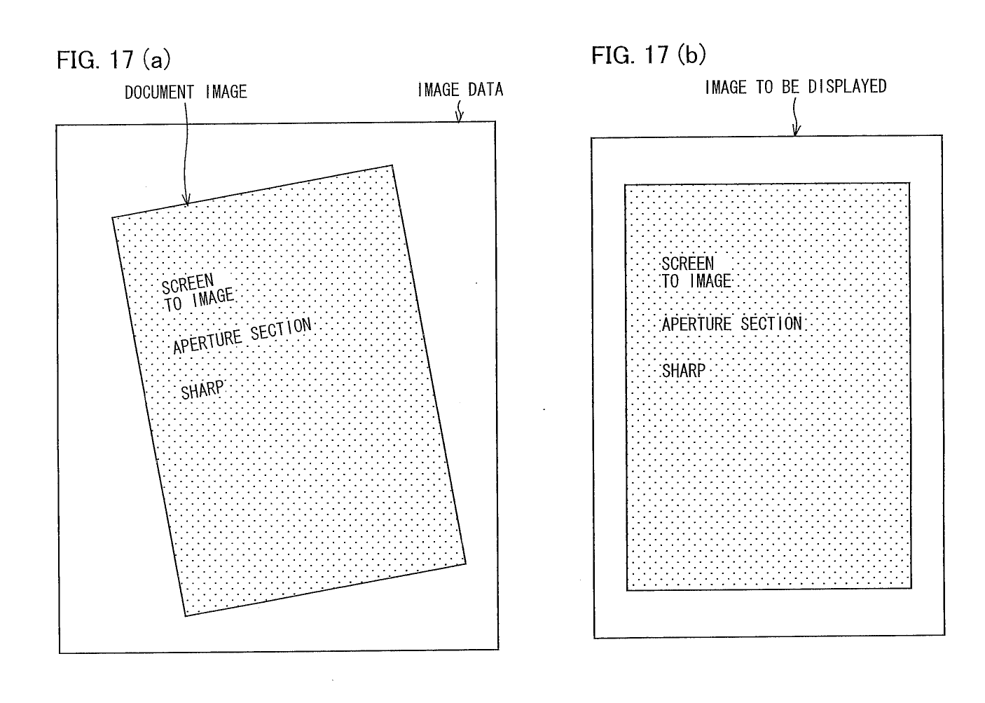

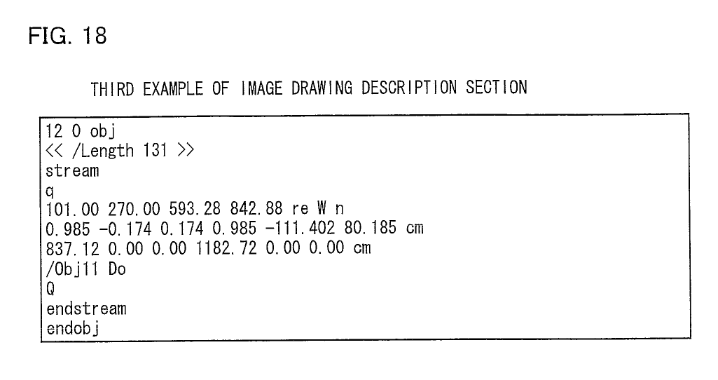

FIG. 17(a) shows an example of image data read by the image input apparatus 2. FIG. 18 shows an example of description contents in the image drawing description section and illustrates conditions to be applied at the time when the image data shown in FIG. 17(a) is drawn. In the example shown in FIG. 18, first a document image region is extracted from the image data and the image of the region extracted is subjected to the skew correction process and then displayed. In the example of FIG. 18, a description “101.00 270.00 593.28 842.88 re W n” indicates contents of the extraction process of the document image region and the description “0.985-0.174 0.174 0.985-111.402 80.185 cm” indicates contents of a skew correction process and a parallel displacement process. FIG. 17(b) shows an image to be displayed in a case where the image is drawn by applying the conditions in FIG. 18 to the image data of FIG. 17(a). In this example, the document image region is extracted and a rotation process (skew correction process) by ten degrees in the clockwise direction around a center of the document is performed. Note that a region outside the area of the document image region is white in the display.

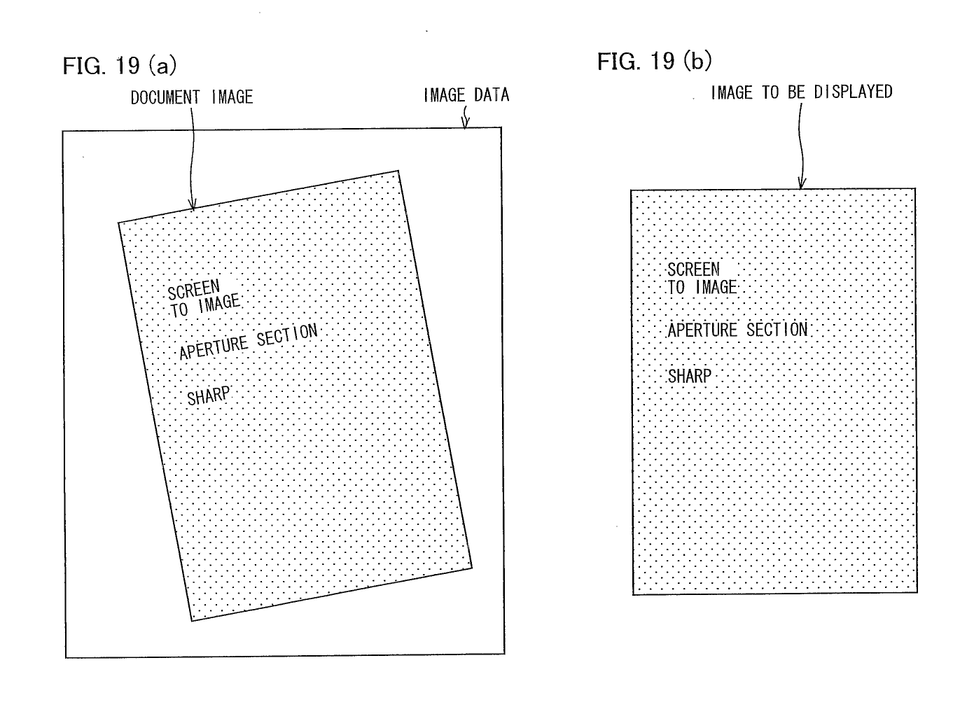

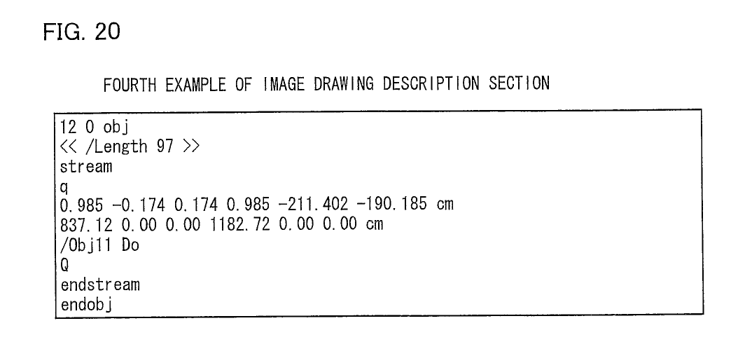

FIG. 19(a) shows an example of image data read by the image input apparatus 2. FIG. 20 shows an example of description contents in the image drawing description section and illustrates conditions to be applied at the time when the image data shown in FIG. 19(a) is drawn. In the example shown in FIG. 20, a section “0.985-0.174 0.174 0.985-211.402-190.185 cm” indicates contents of a skew correction process and a parallel displacement process, and also indicates that a rotation process (skew correction process) by ten degrees in a clockwise direction is to be performed. FIG. 19(b) shows an image to be displayed in a case where the conditions of FIG. 20 is applied to the image data of FIG. 19(a). In an example shown in FIG. 19(b), though an extraction process of a document image is not performed, a display area is set to the same size as a size of the document. Accordingly, an image out of the document image region is configured not to be displayed.

The communication device 5 transmits, to an external device communicably connected via a network, the image file that is inputted from the formatting process section 44. For example, the communication device 5 attaches the image file to an e-mail by using a mail process section (job device) (not shown), and transmits the image file. The external device receives the image file and displays the image file with reference to the draw command embedded in the image drawing description section (command description section). This makes it possible to display, in the external device, the image data that has been subjected to the skew correction process, the top-to-bottom correction process and the image extraction process. Further, it becomes possible to perform, for example, a search process or a sound output process, by using the transparent text data embedded in the image file.

Note that in the present embodiment, the draw command regarding the skew correction process, the top-to-down process, and the image extraction process is embedded in the image file and transmitted. However, the configuration of the present invention is not limited to this.

For example, a draw command regarding at least one of the skew correction process, the top-to-down process, and the image extraction process may be embedded in the image file and transmitted.

Further, a draw command regarding other image process in addition to the above processes or in replacement of any of the processes described above may be embedded in the image file and transmitted. For example, it is possible to embed, in the image file, a draw command for displaying image data whose scale is changed (enlarged or reduced) at a predetermined scaling ratio (a predetermined enlarging or reducing ratio), and then to transmit this draw command.

Alternatively, for example, it is possible to have the following configuration. That is, the document detection section 14 or the transmission data generation section 22 is provided with a scaling ratio calculation section (not shown) for calculating a scaling ratio that is for scaling (enlarging/reducing), to a predetermined size, an image of the image region extracted in the image extraction process. Then, the draw command generation section 43 generates a draw command in accordance with the scaling ratio that is calculated by the scaling ratio calculation section. Subsequently, the formatting process section 44 embeds the draw command into the image file.

For example, the scaling ratio calculation section defines that: the number of pixels in the main scanning direction in the image data read from the document is SX; the number of pixels in the sub-scanning direction in the image data is SY; the number of pixels in the main scanning direction in the drawing area in which an image in accordance with the image data is to be drawn DX; and the number of pixels in the sub-scanning direction in the drawing area is DY. Then, the scaling ratio calculation section calculates the scaling ratio M according to the following formula (6).

MX=DX/SX

MY=DY/SY

M=min(MX,MY) (6)

Further, in the present embodiment, the transparent text data in accordance with the character recognition result is embedded in the image file and transmitted. However, the configuration of the present invention is not limited to this. The transparent text data may be omitted. In a case where the transparent text data is omitted, the character recognition process is not necessary. Therefore, the document detection section 14 may be configured not to output, to the transmission data generation section 22, the binarized image data whose resolution is reduced. Further, in the case where the transparent text data is omitted, the character recognition section 42 may directly output (without subjecting the image data to any process), to the draw command generation section 43, the data inputted from the information extraction section 41.

In a case where the character recognition process is performed, the character recognition process may be performed as follows. First, as shown by a dotted line in FIG. 4, the document detection section 14 outputs, to the document correction section 15, a skew angle of the document image and the binarized image data whose resolution is reduced. Then, the document correction section 15 subjects, to the skew correction process, the binarized image data whose resolution is reduced, and then outputs, to the transmission generation section 22, the image data having been subjected to the skew correction process. Subsequently, the character recognition section 42 of the transmission data generation section 22 performs the character recognition process by using the image data having been subjected to the skew correction. This makes it possible to improve accuracy of the character recognition, as compared with a case where the character recognition is performed based on the image data that has not been subjected to the skew correction yet.

As described above, in the digital color multifunction printer 1 of the present embodiment: the document detection section 14 detects image processing conditions to be applied at the time when a document image is displayed; and the draw command generation section 43 generates a draw command for controlling a computer provided in a destination device so as to cause the computer (i) to perform the image processing in accordance with the conditions at the time when the document image is to be displayed and (ii) then to perform display. Then the formatting process section 44 generates an image file in which the draw command is added to the image data that has not been subjected to the image processing.

As a result, the image data of the document image can be transmitted before the image data is subjected to the image processing. This makes it possible to rapidly perform processing from image reading to image transmission. Further, when the document image is to be displayed, it is possible to cause the computer provided in the destination device to perform the image processing in accordance with the draw command. Therefore, it becomes possible to display the document image in an appropriate condition in the destination device.

Note that though the present embodiment explained, as a example, a case where the formatting process section 44 generates a PDF image file, the configuration of the present invention is not limited to this. The image file may be in any format as long as the image file includes the image data and the conditions to be applied at the time when the image data is to be drawn.

For example, it is possible in a TIFF file or a file in a JPEG format of the EXIF standard, to set a value to a condition to be applied in drawing in a tag corresponding to a parameter of a correction process. For example, in a case where the top-to-bottom correction process (rotation process) is performed, a value corresponding to a desired rotation angle may be set in a 0×112 tag indicative of rotation information. More specifically, the value 1 may be set when the rotation angle is 0′; the value 6 may be set when the rotation angle is 90°; the value 3 may be set when the rotation angle is 180°; and the value 8 may be set when the rotation angle is 270°.

Further, the present embodiment is configured such that, in the regular transmission mode and the simple transmission mode, the image file is transmitted to an external device connected via a network. However, the configuration of the present invention is not limited to this. For example, a destination of the image file may be the storage section 23 provided in the digital color multifunction printer 1 and the image file may be filed in the storage section 23.

In a case where the image file is filed in the storage section 23 of the digital color multifunction printer 1 by using the simple transmission mode, the main control section of the digital color multifunction printer 1 may be configured: to monitor an operation state of the digital color multifunction printer 1; to read out the image file that has been filed in the storage section 23 in the simple transmission mode, when it is detected that a non-operation state, that is, a state where no job process (the image reading process in the image input apparatus 2, various processes in the image processing apparatus 3, the image output process in the image output apparatus 4, and the transmission/reception process in the communication device 5) is performed continues for a predetermined period; to cause the document correction section 15 to perform the skew correction process, the top-to-bottom correction section, and the image extraction process, in accordance with the draw command embedded in the image file; and to store, in the storage section 23, a result of performing these processes or to send the results to the image output apparatus 4 so that an image formation process is performed.

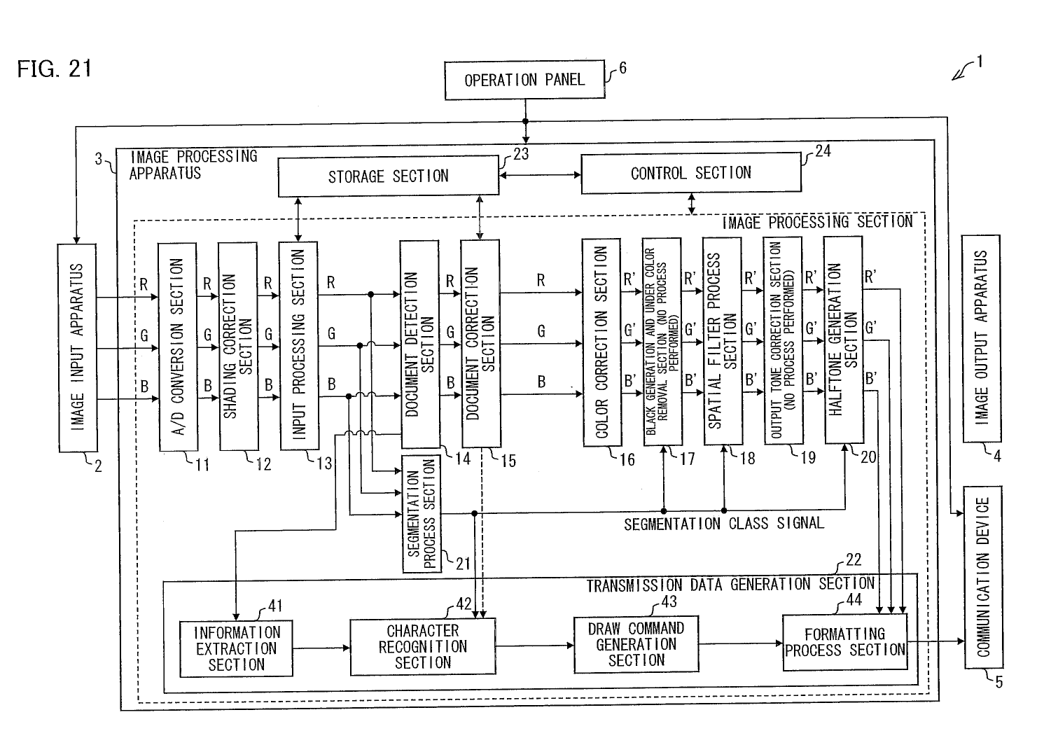

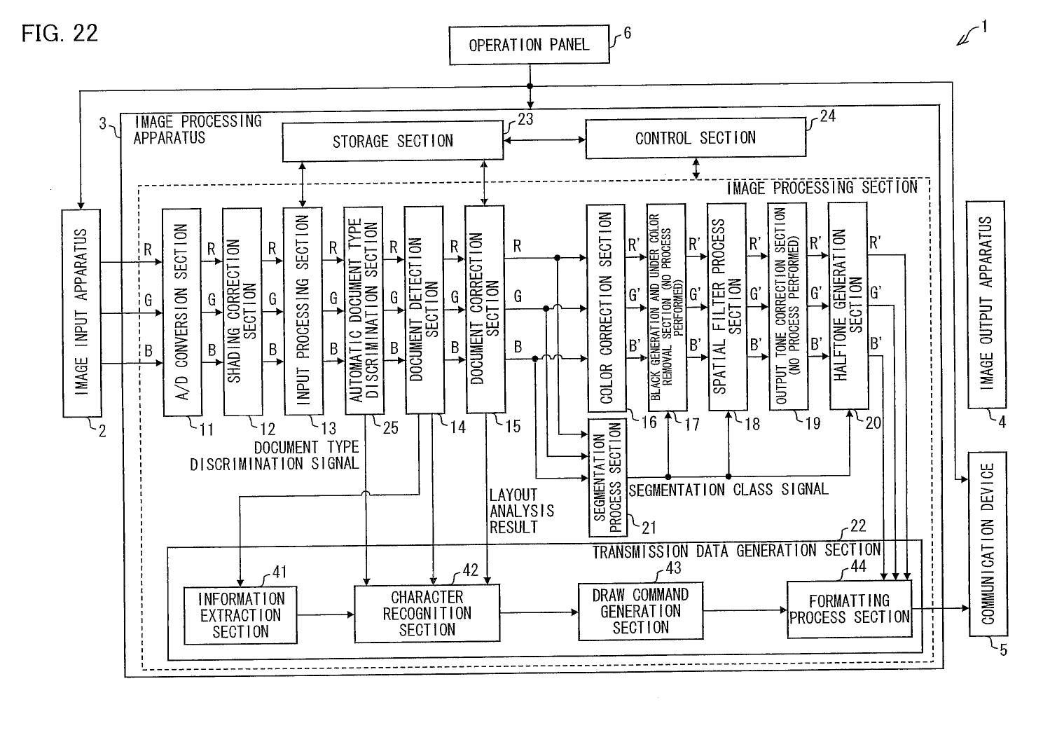

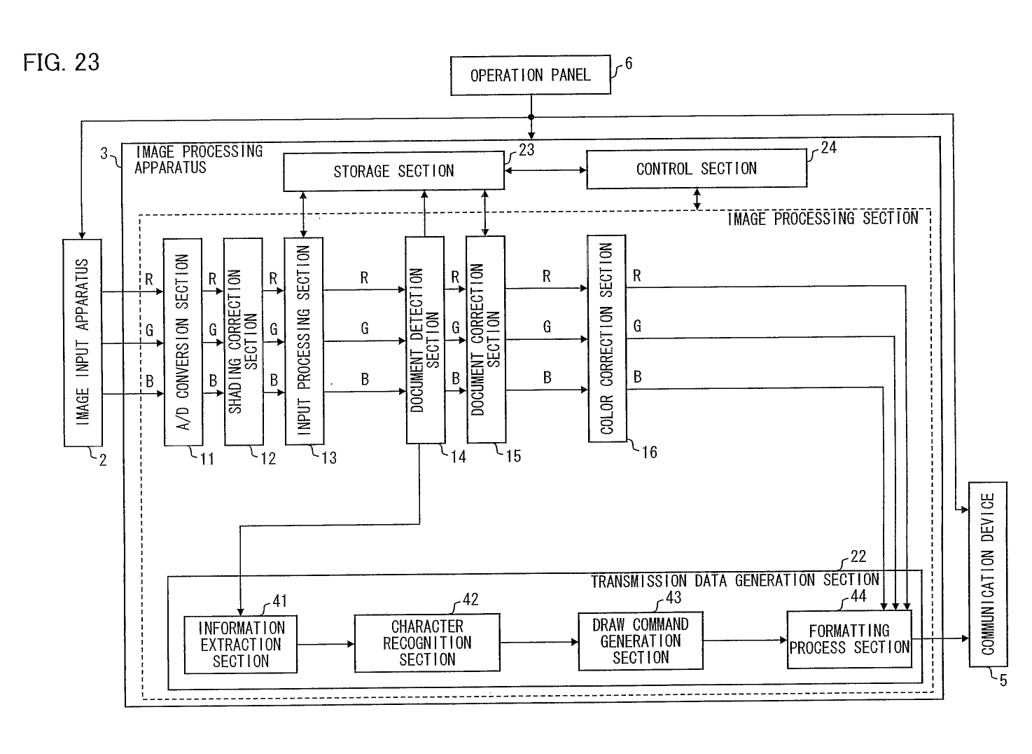

In the present embodiment, it is configured that the character recognition section 42 performs the character recognition process based on the binarized image data whose resolution is reduced and which is inputted from the document detection section 14 or the document correction section 15. However, the configuration of the present invention is not limited to this. For example, as shown in FIG. 21, the configuration may be as follows. That is, the segmentation class signal outputted from the segmentation process section 21 is inputted into the character recognition section 42. Then, the character recognition section 42 generates a text map indicative of a text region (an image region made of pixels each determined to be a text edge), in accordance with the segmentation class signal. Then, the character recognition process is performed only on the text region.

Alternatively, as shown in FIG. 22, the configuration may be as follows. That is, an automatic document type discrimination section 25 for discriminating a type of a document according to image data is provided. The automatic document type discrimination section 25 outputs a document type discrimination signal, which is then inputted into the character recognition section 42. Then, the character recognition section 42 performs the character recognition process only in a case where the document type discrimination signal indicates a document (e.g., a text document, a text/printed-picture document and a text/photograph document) containing a character. A discrimination method of a document type in the automatic document type discrimination section 25 may be any method as long as at least a document containing a text and a document containing no text can be discriminated by the method. For the discrimination method, various conventionally known methods may be used.

The present embodiment explains a case where the present invention is applied to a digital color multifunction printer. However, the application is not limited to this. For example, the present invention may be applied to a monochrome multifunction printer. Further, the present invention may be applied to, for example, a single-function image reading apparatus other than the multifunction printer.

FIG. 23 is a block diagram illustrating an example of a configuration in a case where the present invention is applied to an image reading apparatus. An image reading apparatus 100 shown in FIG. 23 includes an image input apparatus 2, an image processing apparatus 3b, a communication device 5, and an operation panel 6. Respective functions and configurations of the image input apparatus 2, the communication device 5, and the operation panel 6 are substantially the same as those of the digital color multifunction printer 1 described above, and explanations thereof are omitted here.

The image processing apparatus 3b includes an A/D conversion section 11, a shading correction section 12, an input processing section 13, a document detection section 14, a document correction section 15, a color correction section 16, a transmission data generation section 22, a storage section 23, and a control section 24. Further, the transmission data generation section 22 includes an information extraction section 41, a character recognition section 42, a draw command generation section 43, and a formatting process section 44.

The members above provided in the image processing apparatus 3b has functions substantially the same as those in the digital color multifunction printer 1 describe above, except that: the image forming mode is not included; and the image data having been subjected to the color correction process by the color correction section 16 is outputted to the formatting process section 44 and the formatting process section 44 generates, in accordance with the image data inputted from the color correction section 16, an image file to be transmitted to an external device. The image file generated through the processes as described above in the image processing apparatus 3b is transmitted, by the communication device 5, to, for example, a computer or a server communicably connected via a network.

In the explanation of FIG. 1 as described above, a user is to select any one of the image forming mode, the regular transmission mode, and the simple transmission mode in S1. However, the configuration of the present invention is not limited to this.

For example, the configuration may be such that the image formation mode or the image transmission mode (the regular transmission mode and the simple transmission mode are undistinguished in this stage) is selected in S1 of FIG. 1 and than, when the transmission mode is processed, switching between transmission by the regular transmission mode and transmission by the simple transmission mode is performed depending on conditions such as a state of image data obtained by reading a document, a destination in transmission, a transmission method, or a format of an image file to be transmitted.

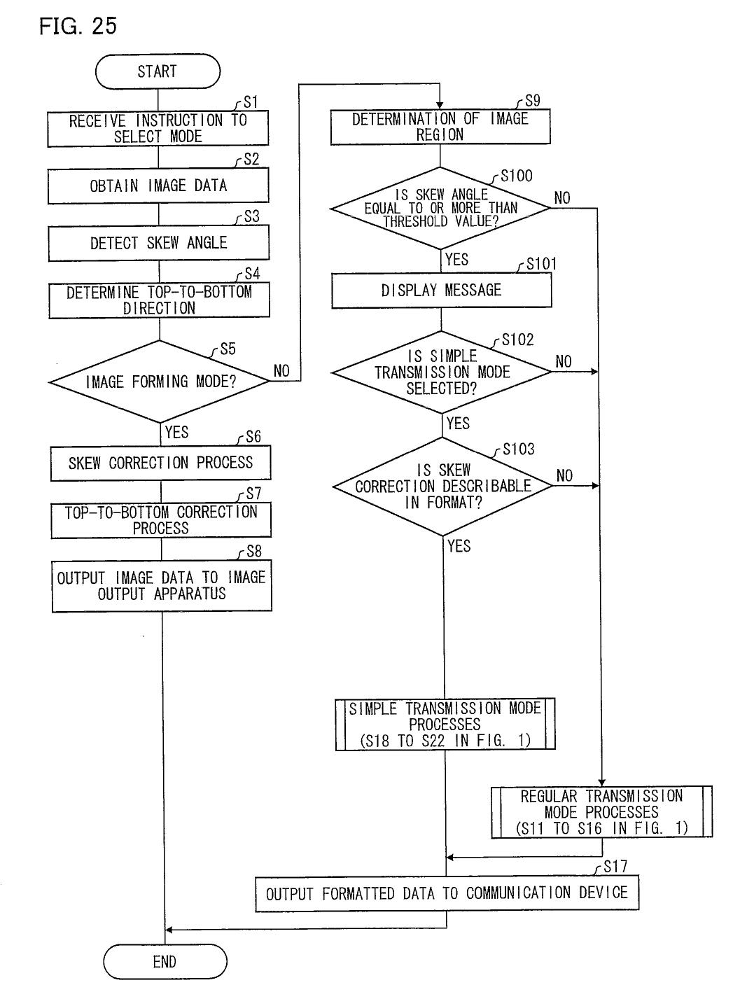

FIG. 25 is a flow chart illustrating a process flow in a case where switching between transmission by the regular transmission mode and the transmission by the simple transmission mode is performed depending on a skew angle of a document image. Note that the steps of FIG. 25 are performed in place of the steps from S9 onward of FIG. 1, in a case where a determination result is “No” in S5 of FIG. 1, that is, in a case where the image transmission mode is selected.

In a case where the control section 24 determines in S5 that the process mode is determined not to be the image forming mode, the control section 24 determines that the image transmission mode is selected. Then, as in the case in FIG. 1, the control section 24 causes the document detection section 14 to perform a determination process of a document image region in the image data (S9).

Next, the control section 24 determines whether or not the skew angle that the document detection section 14 detects in S3 is equal to or more than a predetermined threshold value (S100).

In a case where the control section 24 determines that the skew angle is less than the predetermined threshold, the control section 24 causes respective sections of the image processing apparatus 3 to perform processes of the regular transmission mode, that is, the steps of S11 to S16 in FIG. 16. Then, the control section 24 causes the formatting process section 44 of the transmission data generation section 22 to output, to the communication device 5, the image file generated in the above processes (S17) and ends processing. Note that, when the processes of the regular transmission mode are performed, the image processing apparatus 3 may omit the skew correction process on the image data. That is, in a case where the control section 24 determines that the skew angle is less than the predetermined threshold, the formatting process section 44 of the transmission data generation section 22 may transmit (that is, output to the communication device 5) an image file that is generated by performing the top-to-bottom correction process (S12), the image region extraction process (S13), the character recognition process (S14), the transparent text data generation process (S15), and the formatting process (S16) while the skew correction process of S11 is omitted.

Meanwhile, in a case where the control section 24 determines in S100 that the skew angle is determined to be equal to or more than the predetermined threshold, the control section 24 performs display indicating that the skew angle is equal to or more than the predetermined threshold in the display section of the operation panel 6. Further, the controls section 24 displays, in the display section, a message to encourage a user to input an instruction as to whether to select the simple transmission mode or the regular transmission mode (S101).

Subsequently, the control section 24 determines whether the user has selected the regular transmission mode or the simple transmission mode (S102). In a case where the regular transmission mode is determined to be selected, the control section 24 causes the respective sections of the image processing apparatus 3 to perform the steps of S11 to S16. Then, the control section 24 causes the formatting process section 44 of the transmission data generation section to output, to the communication device 5, the image file generated through the steps S11 to S16 (S17), and ends processing.

Meanwhile, in a case where the control section 24 determines that the simple transmission mode has been selected in S102, the control section 24 determines whether or not a format of the image file is a format in which a draw command for performing the skew correction at the time of display is describable (S103).

Table 2 shows a relation between a format of the image file and each image process that is describable in the draw command. As shown in this table, as examples of the format in which the draw command for performing the skew correction is describable, there are a PDF and an XPS format. Meanwhile, as examples of the format in which the draw command for performing the skew correction is indescribable, there are a JPEG format and a TIFF.

TABLE 2

| | | | Top-to- | |
|---|---|---|---|---|
| | | Skew | Bottom | Scaling |
| Format | Crop | Correction | Correction | Process |
| PDF | Yes | Yes | Yes | Yes |
| TIFF | No | No | Yes | Yes |
| JPEG | No | No | Yes | Yes |
| XPS | Yes | Yes | Yes | Yes |

Yes: Describable,
No: Indescribable

Note that in a case where, for example, a user selects the image transmission mode in an instruction to select a mode in S1, a format of the image file may be selected subsequently to the instruction to select the image transmission mode. Alternatively, after the user selects the regular transmission mode or the simple transmission mode in response to the display in S101, the user may subsequently give an instruction to select a format.

Then, in a case where the control section 24 determines in S103 that the image file is in a format in which the draw command for performing the skew correction is indescribable, the control section 24 causes the respective sections of the image processing apparatus 3 to perform the steps of S11 to S16 in FIG. 1. Then, the control section 24 causes the formatting process section 44 of the transmission data generation section 22 to output, to the communication section 5, an image file generated through the steps (S17) and ends processing.

Meanwhile, in a case where the control section 24 determines in S103 that the image file is in a format in which the draw command for performing the skew correction is describable, the control section 24 causes the respective sections of the image processing apparatus 3 to perform the processes of the simple transmission mode, that is, the steps of S18 to S22 in FIG. 1. Then, the control section 24 causes the communication device 5 to output the image file generated through the steps (S17) and ends processing.

In this way, the control section 24 selects either transmission by the simple transmission mode or transmission by the regular transmission mode, depending on whether or not the document skew angle is equal to or more than the threshold value. This makes it possible not to perform a process for generating the draw command and a process for embedding the draw command in the image file, in a case where the document skew angle is less than the threshold value. As a result, a time for the processing can be shortened and a load required for the processing can be reduced.

Note that in the example of FIG. 25, in a case where the control section 24 determines in S100 that the document skew angle is equal to or more than the document skew angle, the control section 24 causes the display section of the operation panel 6 to display a message to encourage a user to input an instruction to select the simple transmission mode or the regular transmission mode. This allows the user to select transmission by the simple transmission mode or transmission by the regular transmission mode in consideration of a processing speed of a computer performing drawing in accordance with the image file received from the image processing apparatus 3 and/or a memory capacity provided in this computer. Accordingly, it becomes possible to prevent too much load on the computer and/or instability of a display state. Note that the present invention is not limited to the above configuration. For example, the present invention may be configured such that, in a case where the document skew angle is determined in S100 to be equal to or more than the threshold value, the step of S103 is performed while the steps of S101 and S102 are omitted. Further, in a case where the format of the image file transmittable in the image transmission mode is only a format in which the draw command for performing the skew correction is describable, the processes of the simple transmission mode are performed while the step of S103 is omitted.

The present invention may also be configured such that, in a case where the image file is transmitted in the simple transmission mode, a user can select to perform transmission by only the simple transmission mode or to perform both transmission by the simple transmission mode and transmission by the regular transmission mode.

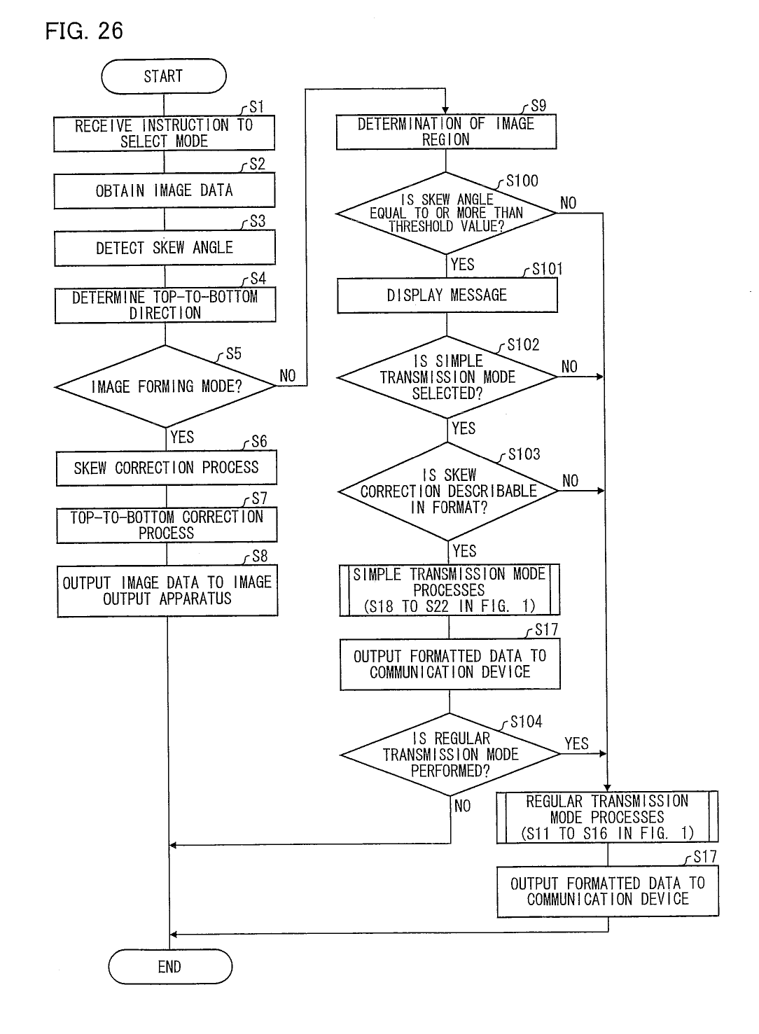

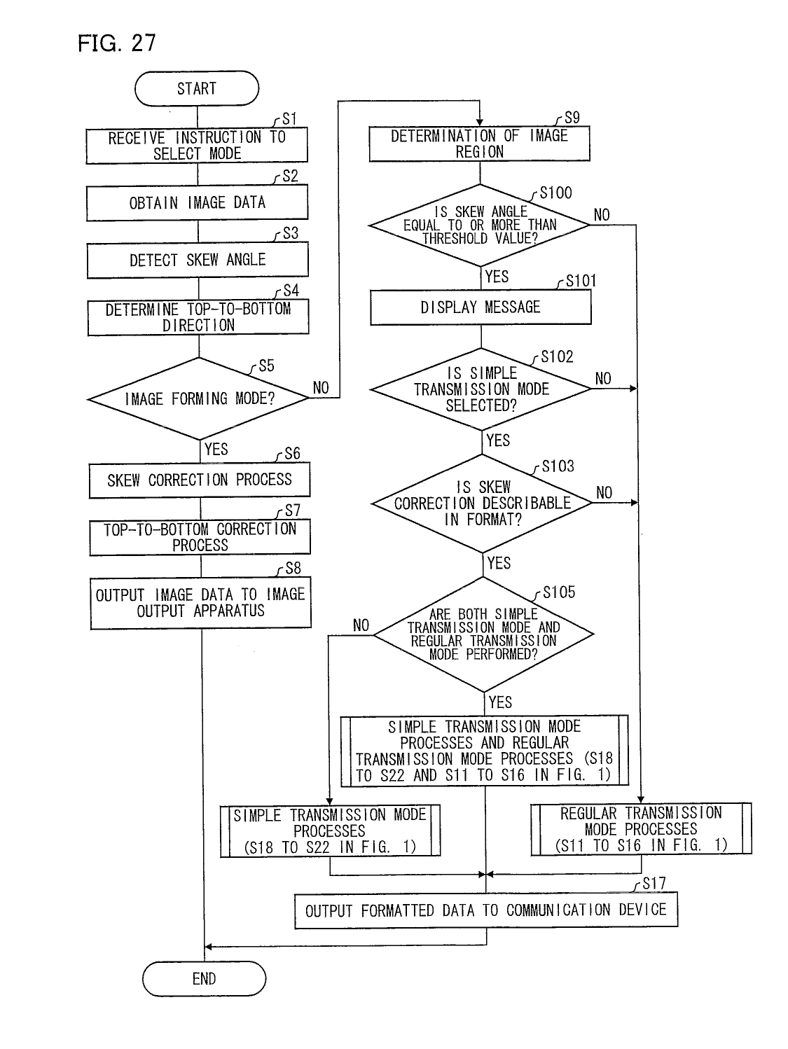

For example, the present invention may be configured as below as shown in FIG. 26. That is, after the transmission process of the image file by the simple transmission mode is completed, the control section 24 determines whether or not it is set to perform both transmission by the simple transmission mode and transmission by the regular transmission mode (S104). In a case where it is set to perform both the transmissions, the control section 24 causes the transmission data generation section 22 to output, to the communication device 5, the image file generated through the processes (S11 to S16) of the regular transmission mode (S17) and then ends processing. In a case where the control section 24 determines in S104 that the transmission by the regular transmission mode is not to be performed, the control section 24 may directly end the processing. Note that the setting described above may be set in advance by a user from the operation panel 6 or set at the time when the user inputs a response to the display of S101.

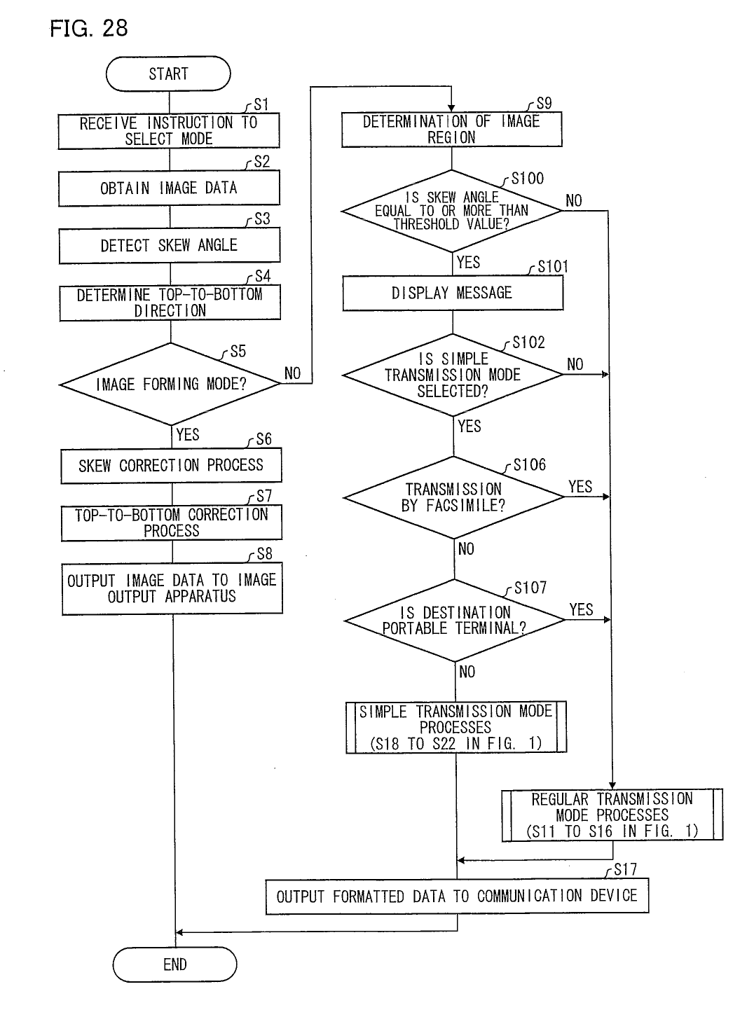

Further, in the example of FIG. 26, after the transmission by the simple transmission mode is completed, the control section 24 determines whether or not it is set to perform both the transmission by the simple transmission mode and the transmission by the regular transmission mode. However, the configuration of the present invention is not limited to this. For example, before the transmission by the simple transmission mode is started, the above determination may be made. FIG. 27 is a flow chart showing a process flow in such a case. Note that the processes in FIG. 27 is the same as those in FIG. 25, except for the processes after determination in S103 such that the format of the image file is a format in which the draw command for performing the skew correction at the time of display is describable.

In a case where it is determined in S103 that the format of the image file is a format in which the draw command for performing the skew correction at the time of display is describable, the control section 24 determines whether or not it is set to perform both the transmission by the simple transmission mode and the transmission by the regular transmission mode (S105).

In a case where the control section 24 determines in S105 that it is set to perform both transmission by the simple transmission mode and transmission by the regular transmission mode, the control section 24 causes the respective sections of the image processing apparatus 3 to perform the processes (the steps of S18 to S22 in FIG. 1) of the simple transmission mode and the processes (the steps of S11 to S16) of the regular transmission mode. Then, the control section 24 causes the communication device 5 to output both the image file of the simple transmission mode and the image file of the regular transmission mode (S17), and ends processing. Note that (i) the processes of the simple transmission mode and the processes of the regular transmission mode may be performed concurrently, or alternatively (ii) the processes of the regular transmission mode may be performed after the processes of the simple transmission mode are performed.

Meanwhile, in a case where the control section 24 determines in S105 that it is set to perform only transmission by the simple transmission mode, the control section 24 causes the respective sections of the image forming apparatus 3 to perform the processes (the steps of S18 to S22 in FIG. 1) of the simple transmission mode. Then, the control section 24 causes the formatting process section 44 of the transmission generation section 22 to output, to the communication device 5, the image file generated through the processes (S17), and ends processing.

In this way, both of the image file of the simple transmission mode and the image file of the regular transmission mode are transmitted. This allow a destination device to use one of the image files depending on an application in a case where the image files are used for different applications. For example, the following usage is possible. That is, a reading state is checked in advance by using the image file that is received first in the simple transmission mode, whereas the subsequently received image file of the regular transmission mode is stored as a public data in a public server so that the image file becomes available through a computer, a mobile phone, or the like.

Further, it may be configured to switch between transmission by the simple transmission mode and transmission by the regular transmission mode, depending on a destination of the image file and/or a transmission method of the image file. FIG. 28 is a flow chart showing a process flow in such a case. Note that the processes in FIG. 28 are the same as the processes in FIG. 25 except that the steps of S106 and S107 in FIG. 25 are performed in place of the step of S103 in FIG. 25.

In a case where the control section 24 determines in S102 that the simple transmission mode is selected, the control section 24 determines whether the transmission method is transmission by an e-mail or transmission by a facsimile (S106). In a case where the control section 24 determines that the transmission method is transmission by a facsimile, the control section 24 causes the respective sections of the image processing apparatus 3 to perform the processes (the steps of S11 to S16 in FIG. 1) of the regular transmission mode. Then, the control section 24 causes the formatting process section 44 of the transmission data generation section 22 to output, to the communication device 5, the image file generated through the processes (S17), and ends the processing.

Meanwhile, in a case where the control section 24 determines in S106 that the transmission method is transmission by an e-mail, the control section 24 determines whether or not a destination is a portable terminal (S107). Note that whether the destination is a portable terminal is determined, for example by analyzing a destination address of the e-mail. More specifically, in a case where an end of the mail address corresponds to a portable phone company, for example, docomo.ne.jp, ezweb.ne.jp, or softbank.ne.jp, the destination is determined to be a portable terminal. Note that end information of the mail address for determining whether the destination is a portable terminal may be additionally registered as appropriate.

Further, in a case where the control section 24 determines in S107 that the destination is a portable terminal, the control section 24 causes the respective sections of the image processing apparatus 3 to perform the processes (the steps of S11 to S16 in FIG. 1) of the regular transmission mode. Then, the control section 24 causes the formatting process section 44 of the transmission data generation section 22 to output, to the communication device 5, the image file generated through the processes (S17), and ends the processing.

Meanwhile, in a case where the control section 24 determines that the destination is not a portable terminal, the control section 24 causes the respective sections of the image processing apparatus 3 to perform the processes (the steps of S18 to S22 in FIG. 1) of the simple transmission mode. Then, the control section 24 causes the formatting process section 44 of the transmission data generation section 22 to output, to the communication device 5, the image file generated through the processes (S17), and ends the processing.

Note that though, in the example of FIG. 28, the steps of S106 and S107 in FIG. 28 are performed in place of the step of S103 in FIG. 25, the configuration of the present invention is not limited to this. For example, it is possible to combine any of the processes of FIG. 25 to FIG. 27 and the processes of FIG. 28, for example.

The present embodiment is configured such that, in the case of the regular transmission mode, the image processing apparatus 3 generates and transmits an image file obtained by formatting the transparent text data and the image data having been subjected to image processing such as skew correction and top-to-bottom correction. However, the configuration of the present invention is not limited to this. For example, the configuration may be such that the image processing apparatus 3 transmits an image file that does not include the transparent text data, in the case of the regular transmission mode. Further, in the case of the regular transmission mode, the image processing apparatus 3 may transmit image data that has not been subjected to image processing such as skew correction and top-to-bottom correction. Alternatively, in the case of the regular transmission mode, the image processing apparatus 3 may transmit an image file including the transparent text data and the image data that has not been subjected to image processing such as skew correction and top-to-bottom correction.

Further, depending on usage of the image file in a destination device, it is possible to switch between transmission by the regular transmission mode and transmission by the simple transmission mode. For example, in a case where the image file is directly used in, for example, OCR (Optical Character Recognition) or in a case where the image file is subjected to an editing process such as pasting of the image file, the image processing apparatus 3 may transmit the image data having been subjected to image processing in the regular transmission mode. Whereas, in a case where the image file is not directly used by, for example, an OCR or in a case where the image file is not subjected to an editing process, the image processing apparatus 3 may transmit the image file including the draw command and the image data that has not been subjected to image processing in the simple transmission mode.

In the present embodiment, each block in the digital color multifunction printer 1 or the image reading apparatus 100 may be realized by software by using a processor such as a CPU. In such a case, the digital color multifunction printer 1 or the image reading apparatus 100 includes a CPU (central processing unit) that executes the order of a control program for realizing the aforesaid functions, a ROM (read only memory) that stores the control program, a RAM (random access memory) that develops the control program in an executable form, and a storage device (storage medium), such as a memory, that stores the control program and various types of data therein. With this arrangement, the object of the present invention is realized by a predetermined storage medium. The storage medium stores, in a computer-readable manner, program codes (executable code program, intermediate code program, and source program) of the control program of the digital color multifunction printer 1 or the image reading apparatus 100 of the present invention, each of which is software for realizing the aforesaid functions. The storage medium is provided to the digital color multifunction printer 1 or the image reading apparatus 100. With this arrangement, the digital color multifunction printer 1 or the image reading apparatus 100 (alternatively, CPU or MPU) as a computer reads out and executes the program code stored in the storage medium provided.

The storage medium may be a tape such as a magnetic tape or a cassette tape; a disc such as a magnetic disk including a Floppy® disc and a hard disk, and an optical disk including a CD-ROM, an MO, an MD, a DVD, and a CD-R; a card such as an IC card (including a memory card) and an optical card; or a semiconductor memory, such as a mask ROM, an EPROM, an EEPROM, and a flash ROM.

Further, the digital color multifunction printer 1 or the image reading apparatus 100 of the present invention may be arranged so as to be connectable to a communications network so that the program code is supplied to the digital color multifunction printer 1 or the image reading apparatus 100 through the communications network. The communications network is not to be particularly limited. Examples of the communications network include the Internet, an intranet, an extranet, LAN, ISDN, VAN, a CATV communications network, a virtual private network, a telephone network, a mobile communications network, and a satellite communications network. Further, a transmission medium that constitutes the communications network is not particularly limited. Examples of the transmission medium include (i) wired lines such as IEEE 1394, USB, power-line carrier, cable TV lines, telephone lines, and ADSL lines and (ii) wireless connections such as IrDA and infrared ray used in remote control, Bluetooth®, 802.11, HDR, a mobile phone network, satellite connections, and a terrestrial digital network. Note that the present invention can be also realized by the program codes in the form of a computer data signal embedded in a carrier wave which is embodied by electronic transmission.

Each block of the digital color multifunction printer 1 or the image reading apparatus 100 is not limited to the block realized by software, but may be constituted by hardware logic or a combination of (i) hardware performing a part of the processes and (ii) operation means executing software performing control of the hardware and the rest of the processes.

As described above, the image processing apparatus of the present invention includes: a formatting process section for generating an image file obtained by formatting, into data of a predetermined format, image data of a document image obtained by reading a document; a condition detection section for detecting, in accordance with the image data, an image processing condition to be applied at a time when the document image is drawn; a draw command generation section for generating a draw command for controlling a computer so as to cause the computer to draw the document image in a state in which image processing in accordance with the image processing condition has been performed, at the time when the document image is drawn; an image processing section for subjecting the image data to the image processing in accordance with the image processing condition detected by the condition detection section; and a control section for controlling an operation of each of the formatting process section, the condition detection section, the draw command generation section, and the image processing section, so that: in a case where the image processing condition detected by the condition detection section satisfies a predetermined requirement, the control section causes the formatting process section to perform a process of a simple mode; and in a case the image processing condition detected by the condition detection section does not satisfy the predetermined requirement, the control section causes the formatting process section to perform a process of a regular mode, in the regular mode, the formatting process section generating an image file obtained by formatting the image data on which the image processing section has performed the image processing, in the simple mode, the formatting processing section generating an image file obtained by adding the draw command generated by the draw command generation section to the image data that has not been subjected to the image processing.

According to the configuration, in a case where the condition detected satisfies the predetermined requirement, an image file is generated according to the image data that is for the document image and that has not been subjected to the image processing. This makes it possible to rapidly perform a process such as transmission or filing of the image file. Further, when the document image is drawn (e.g., when the document image is displayed on a display or the document image is printed on a recording material), it is possible to control a computer so that the computer draws the document image in the state in which the image processing in accordance with the image processing condition has been performed.

Further, in a case where the condition detected does not satisfy the predetermined requirement, the control section causes the image processing section to perform, on the image data, image processing in accordance with the condition detected by the condition detection section and also causes the formatting process section to generate the image file in accordance with the image data having been subjected to the image processing. Accordingly, for example, if the requirement is set in accordance with a relation between the condition detected by the condition detection section and a load or a processing speed of the image processing apparatus, it becomes possible to appropriately switch whether or not to perform image processing in consideration of the load, the processing speed, or the like of the image processing apparatus at the time when an image file generated previously in the regular mode or the simple mode is subjected to drawing.

Further, the image processing apparatus of the present invention may be configured such that: the condition detection section detects, as the image processing condition, a skew angle of the document image with respect to a reference direction of the image data; the draw command generation section generates a draw command for causing the computer to perform a skew correction process in which an angle of the document image is caused to coincide with or come closer to the reference direction, in accordance with the skew angle detected by the condition detection section; and the case where the image processing condition satisfies the predetermined requirement is a case where the skew angle detected by the condition detection section is equal to or more than a predetermined threshold value.

In general, in the skew correction process (rotation process) of the image data, the larger the skew angle becomes, the heavier the load on operation means becomes and the longer the processing time becomes. In order to solve this problem, in the above configuration, in a case where the document skew angle with respect to a reference direction is equal to or more than a threshold, processing in the simple mode is performed. In the simple mode, an image file is generated so as to include image data that has not been subjected to the image processing and a draw command for drawing the image data in a state where the skew is corrected at the time of drawing, while no image processing (skew correction process) is performed in the image processing apparatus. Meanwhile, in a case where the document skew angle with respect to the reference direction is less than the threshold, processing in the regular mode is performed. In the regular mode, the image processing (skew correction process) is performed in the image processing apparatus and an image file is generated by formatting the image data having been subjected to the image processing. This makes it possible to select and use either the regular mode or the simple mode in accordance with a time required for image processing (skew correction process).

Further, the image processing apparatus may be arranged such that: the formatting process section selects a data format into which the image data is formatted, among a plurality of predetermined data formats; and the control section determines whether or not the data format of the image file is a data format in which the draw command is describable so that, in a case where the data format of the image file is a data format in which the draw command is indescribable, the control section controls the operation of each of the formatting process section, the condition detection section, the draw command generation section, and the image processing section so as to cause each of these sections to perform a process of the regular mode regardless of whether or not the image processing condition detected by the condition detection section satisfies the predetermined requirement.

According to the configuration, in a case where a data format of the image file is a data format in which the draw command is indescribable, the image file is generated in the regular mode. This makes it possible to draw an image having been subjected to appropriate image processing regardless of the data format. Meanwhile, in a case where the data format of the image file is a data format in which the draw command is describable, an image file of the simple mode is generated. This shortens the time up to output of the image file.

The image processing apparatus may further include: a transmission section for transmitting the image file to another device; and a storage section storing information for determining whether or not the another device is a device suitable for the image processing in accordance with the draw command, the control section determining, based on the information stored in the storage section, whether or not the another device selected as a destination of the image file is a device suitable for the image processing in accordance with the draw command, so that, in a case where the another device is determined to be unsuitable for the image processing in accordance with the draw command, the control section controls the operation of each of the formatting process section, the condition detection section, the draw command generation section, and the image processing section so as to cause each of these sections to perform the process of the regular mode regardless of whether or not the image processing condition detected by the condition detection section satisfies the predetermined requirement.

According to the configuration, the simple mode or the regular mode can be selected for generating the image file, depending on a destination device. This makes it possible to prevent too much load on the destination device or an increase in processing time at the time of drawing in the destination device, by transmitting the image file of the regular mode in a case where, for example, the destination device has a low operation performance for the image processing (e.g., in a case where the destination device is a portable terminal device, or in a case where the destination device takes a longer time for the image processing than the image processing device that is a source of the image file). Further, it also becomes possible to shorten a time up to transmission of the image file and to perform rapidly and appropriately the image processing in the destination device, by transmitting the image file of the simple mode in a case where the destination device has a high operation performance (e.g., in a case where the destination device can perform the image processing in a shorter time than the image processing apparatus that is the source of the image file.

The image processing apparatus may further include: a transmission section for transmitting the image file to another device, the transmission section selecting any one of a plurality of transmission methods so as to transmit the image file to the another device, the control section determining whether or not a selected transmission method is a transmission method allowing transmission of the draw command in a form causing a computer provided in the another device to execute the draw command, so that, in a case where the transmission method is determined to be the transmission method not allowing the transmission of the draw command in the form causing the computer to execute the draw command, the control section controls the operation of each of the formatting process section, the condition detection section, the draw command generation section, and the image processing section so as to cause each of these sections to perform the process of the regular mode regardless of whether or not the image processing condition detected by the condition detection section satisfies the predetermined requirement.

According to the configuration, in accordance with the transmission method of the image file, it is possible to select the image file of the simple mode or the image file of the regular mode for transmission of the image file. For example, in a case where the transmission method is transmission by facsimile, the image of the regular mode is transmitted; whereas in a case where the transmission method is transmission via an e-mail, the image file of the simple mode is transmitted. In this way, a generation method of the image file can be changed depending on the transmission method. This allows a destination device to appropriately draw an image having been subjected to the image processing in accordance with the image file generated in the regular mode, even when, for example, the destination device is a device, such as a facsimile machine, whose image-processing performance is generally low. Further, for example, in a case where the destination device has a high image-processing performance, the time before transmission of the image file can be shortened and the destination device can perform appropriate image processing by transmitting the image file including the draw command and the image data that has not been subjected to the image processing yet.

An image reading apparatus of the present invention includes: an image reading section for obtaining image data of a document image by reading a document; and any one of the image processing apparatuses described above.

According to the configuration, it is possible to rapidly perform processes such as transmission of the image file or filing of the image file regarding the image data read from a document image. Further, when the document image is drawn (for example, when the document image is displayed on the display or printed on a recording material), a computer can be controlled so as to draw the document image having been subjected to the image processing in accordance with the draw command.

An image transmitting device of the present invention includes: any one of the image processing apparatuses described above; and a communication section transmitting, to another device communicably connected, the image file generated by the formatting process section.

This configuration makes it possible to transmit the image data of the document image before the image data is subjected to the image processing. This makes it possible to rapidly perform processing from image reading to image transmission while reducing a load on the image processing apparatus. Further, when the document image is to be drawn in the destination device, the document image can be drawn in a state in which the image processing has been performed in accordance with the draw command. Therefore, it becomes possible to draw the document image in an appropriate state.

An image forming apparatus of the present invention includes: any one of the image processing apparatuses described above; a storage section in which the image file generated by the formatting process section is stored; an image processing section reading out the image file stored in the storage section and performing the image processing in accordance with the draw command included in the image file; and an image forming section for printing, on a recording material, an image in accordance with the image data having been subjected to the image processing.

According to the configuration, an image file is stored in the storage section while the image processing has not been performed on the image data of the document image. This makes it possible to rapidly perform processes from reading of the document to storage of the image file. In addition, when the image corresponding to the image data is printed, the printing can be performed after the image file read out from the storage section has been subjected to the image processing in accordance with the draw command. Therefore, the image in accordance with the document image can be printed in an appropriate state.

An image processing method of the present invention in an image processing apparatus generating an image file obtained by formatting, into data of a predetermined format, image data of a document image obtained by reading a document, the image processing method includes the steps of: detecting, by a condition detection section provided in the image processing apparatus, an image processing condition to be applied at a time when the document image is drawn, in accordance with the image data; and determining, by a control section provided in the image processing apparatus, whether or not the image processing condition detected in the step of detecting the image processing condition satisfies a predetermined requirement, in a case where the image processing condition detected in the step of detecting the image processing condition is determined to satisfy the predetermined requirement, the control section (i) causing the draw command generation section provided in the image processing apparatus to generate a draw command for controlling a computer so as to cause the computer to draw the document image in a state in which image processing in accordance with the image processing condition has been performed, at the time when the document image is drawn, and (ii) causing an image file generation section provided in the image processing apparatus to generate an image file in which the draw command is added to the image data that has not been subjected to the image processing, in a case where the image processing condition detected in the step of detecting the image processing condition is not determined to satisfy the predetermined requirement, the control section (i) causing the image processing section provided in the image processing apparatus to subject the image data to the image processing in accordance with the image processing condition detected in the step of detecting the image processing condition, and (ii) causing the image file generation section to generate an image file obtained by formatting the image data that has been subjected to the image processing.

According to the method, in a case where the condition detected satisfies the predetermined requirement, an image file is generated according to the image data that is for the document image and that has not been subjected to the image processing. This makes it possible to rapidly perform a process such as transmission or filing of the image file. Further, when the document image is drawn (e.g., when the document image is displayed on a display or the document image is printed on a recording material), it is possible to control a computer so that the computer draws the document image in the state in which the image processing in accordance with the image processing condition has been performed.

Further, in a case where the condition detected does not satisfy the predetermined requirement, the image processing in accordance with the condition detected by the condition detection section is performed on the image data and the image file in accordance with the image data having been subjected to the image processing is generated. Accordingly, for example, if the requirement is set in accordance with a relation between the image processing condition detected by the step of detecting the image processing condition and a load or a processing speed of the image processing apparatus, it becomes possible to appropriately switch whether or not to perform the image processing in consideration of the load, the processing speed, or the like of the image processing apparatus at the time when an image file generated previously in the regular mode or the simple mode is subjected to drawing.

Note that the image processing apparatus may be realized by a computer. In such a case, the scope of the present invention encompasses an image processing program and a computer-readable storage medium storing the image processing program for realizing the image processing apparatus by causing the computer to operate as the sections described above.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is suitably applied to an image processing apparatus, an image reading apparatus, and an image formation apparatus each of which is for subjecting image data read from a document to a predetermined process and transmit processed image data to another device.

1. An image processing apparatus comprising:
a formatting process section for generating an image file obtained by formatting, into data of a predetermined format, image data of a document image obtained by reading a document;
a condition detection section for detecting, in accordance with the image data, an image processing condition to be applied at a time when the document image is drawn;
a draw command generation section for generating a draw command for controlling a computer so as to cause the computer to draw the document image in a state in which image processing in accordance with the image processing condition has been performed, at the time when the document image is drawn;
an image processing section for subjecting the image data to the image processing in accordance with the image processing condition detected by the condition detection section; and
a control section for controlling an operation of each of the formatting process section, the condition detection section, the draw command generation section, and the image processing section, so that:
in a case where the image processing condition detected by the condition detection section satisfies a predetermined requirement, the control section causes the formatting process section to perform a process of a simple mode; and
in a case the image processing condition detected by the condition detection section does not satisfy the predetermined requirement, the control section causes the formatting process section to perform a process of a regular mode,
in the regular mode, the formatting process section generating an image file obtained by formatting the image data on which the image processing section has performed the image processing,
in the simple mode, the formatting processing section generating an image file obtained by adding the draw command generated by the draw command generation section to the image data that has not been subjected to the image processing.

2. The image processing apparatus as set forth in claim 1, wherein:
the condition detection section detects, as the image processing condition, a skew angle of the document image with respect to a reference direction of the image data;
the draw command generation section generates a draw command for causing the computer to perform a skew correction process in which an angle of the document image is caused to coincide with or come closer to the reference direction, in accordance with the skew angle detected by the condition detection section; and
the case where the image processing condition satisfies the predetermined requirement is a case where the skew angle detected by the condition detection section is equal to or more than a predetermined threshold value.

3. The image processing apparatus as set forth in claim 1 wherein:
the formatting process section selects a data format into which the image data is formatted, among a plurality of predetermined data formats; and
the control section determines whether or not the data format of the image file is a data format in which the draw command is describable so that, in a case where the data format of the image file is a data format in which the draw command is indescribable, the control section controls the operation of each of the formatting process section, the condition detection section, the draw command generation section, and the image processing section so as to cause each of these sections to perform a process of the regular mode regardless of whether or not the image processing condition detected by the condition detection section satisfies the predetermined requirement.

4. The image processing apparatus as set forth in claim 1 further comprising:
a transmission section for transmitting the image file to another device; and
a storage section storing information for determining whether or not the another device is a device suitable for the image processing in accordance with the draw command,
the control section determining, based on the information stored in the storage section, whether or not the another device selected as a destination of the image file is a device suitable for the image processing in accordance with the draw command, so that, in a case where the another device is determined to be unsuitable for the image processing in accordance with the draw command, the control section controls the operation of each of the formatting process section, the condition detection section, the draw command generation section, and the image processing section so as to cause each of these sections to perform the process of the regular mode regardless of whether or not the image processing condition detected by the condition detection section satisfies the predetermined requirement.

5. The image processing apparatus as set forth in claim 1 further comprising:
a transmission section for transmitting the image file to another device,
the transmission section selecting any one of a plurality of transmission methods so as to transmit the image file to the another device,
the control section determining whether or not a selected transmission method is a transmission method allowing transmission of the draw command in a form causing a computer provided in the another device to execute the draw command, so that, in a case where the transmission method is determined to be the transmission method not allowing the transmission of the draw command in the form causing the computer to execute the draw command, the control section controls the operation of each of the formatting process section, the condition detection section, the draw command generation section, and the image processing section so as to cause each of these sections to perform the process of the regular mode regardless of whether or not the image processing condition detected by the condition detection section satisfies the predetermined requirement.

6. An image forming apparatus comprising:
an image processing apparatus as set forth in claim 1;
a storage section in which the image file generated by the formatting process section is stored;
an image processing section reading out the image file stored in the storage section and performing the image processing in accordance with the draw command included in the image file; and
an image forming section for printing, on a recording material, an image in accordance with the image data having been subjected to the image processing.

7. An image processing method in an image processing apparatus generating an image file obtained by formatting, into data of a predetermined format, image data of a document image obtained by reading a document, the image processing method comprising the steps of:
detecting, by a condition detection section provided in the image processing apparatus, an image processing condition to be applied at a time when the document image is drawn, in accordance with the image data; and
determining, by a control section provided in the image processing apparatus, whether or not the image processing condition detected in the step of detecting the image processing condition satisfies a predetermined requirement,
in a case where the image processing condition detected in the step of detecting the image processing condition is determined to satisfy the predetermined requirement, the control section (i) causing the draw command generation section provided in the image processing apparatus to generate a draw command for controlling a computer so as to cause the computer to draw the document image in a state in which image processing in accordance with the image processing condition has been performed, at the time when the document image is drawn, and (ii) causing an image file generation section provided in the image processing apparatus to generate an image file in which the draw command is added to the image data that has not been subjected to the image processing,
in a case where the image processing condition detected in the step of detecting the image processing condition is not determined to satisfy the predetermined requirement, the control section (i) causing the image processing section provided in the image processing apparatus to subject the image data to the image processing in accordance with the image processing condition detected in the step of detecting the image processing condition, and (ii) causing the image file generation section to generate an image file obtained by formatting the image data that has been subjected to the image processing.

8. A computer-readable storage medium storing a program for operating an image processing apparatus as set forth in claim 1, the program for causing a computer to operate as each of the formatting process section, the condition detection section, the draw command generation section, and the image processing section.
